(19) United States
(12) Patent Application Publication
(10) Pub. No.: US 2022/0179424 A1
(43) Pub. Date: Jun. 9, 2022

(54) SYSTEMS AND METHODS FOR AUTONOMOUS NAVIGATION ON SIDEWALKS IN VARIOUS CONDITIONS

(71) Applicant: REGENTS OF THE UNIVERSITY OF MINNESOTA, MINNEAPOLIS, MN (US)

(72) Inventors: Max Donath, Minneapolis, MN (US); Reed Johnson, Minneapolis, MN (US)

(21) Appl. No.: 17/116,881

(22) Filed: Dec. 9, 2020

(51) Int. Cl. G05D 1/02; G01S 19/42; G05D 1/00; G01C 21/34; G01C 21/36

(52) U.S. Cl. CPC G05D 1/0214; G01S 19/42; G01C 21/3691; G05D 1/0088; G01C 21/3461; G05D 1/0268

(57) ABSTRACT

The disclosure provides a method for determining a location of an unmanned ground vehicle (UGV). The method includes receiving LIDAR data with a computer system, the LIDAR data being received from at least one LIDAR sensor mounted to the UGV, receiving Global Navigation Satellite System (GNSS) data with the computer system, the GNSS data being received from at least one GNSS sensor mounted to the UGV, and computing location data with the computer system, the location data being computed by fusing the LIDAR data and the GNSS data to determine a location of the UGV.

### BACKGROUND

There has been much research and progress in the field of unmanned ground vehicles (UGVs). From the increasing popularity of autonomous cars to package delivering robots, the potential applications seem limitless. However, as much as the developers of UGVs would like you to believe, they are far from perfect. Many of these systems begin to fail in inclement weather, such as snow, which is why they are primarily tested in locations with good weather year-round. Additionally, some systems cannot navigate without localization via Global Navigation Satellite System (GNSS). In some environments, such as urban environments, tree canopy and buildings hinder the quality of reception of GNSS, which can negatively impact the performance of the system. GNSS is often combined with inertial measurement units (INS) or wheel encoders to supplement the localization in low quality GNSS areas. However, both INS and wheel encoders are susceptible to drift or slip and the localization scheme will fail if the vehicle travels too far between receiving accurate GNSS positions. Thus, improved systems and method for autonomous navigation in inclement weather and/or urban environments are desired.

### SUMMARY OF THE DISCLOSURE

The present disclosure addresses the aforementioned drawbacks by providing systems and methods for autonomous vehicles that can navigate sidewalks using GNSS as well as LiDAR sensors.

It is an aspect of the present disclosure to provide a method for determining a location of an unmanned ground vehicle (UGV). The method includes receiving LIDAR data with a computer system, the LIDAR data being received from at least one LIDAR sensor mounted to the UGV, receiving Global Navigation Satellite System (GNSS) data with the computer system, the GNSS data being received from at least one GNSS sensor mounted to the UGV, and computing location data with the computer system, the location data being computed by fusing the LIDAR data and the GNSS data to determine a location of the UGV.

It is another aspect of the present disclosure to provide a method for mapping a pathway. The method includes receiving LIDAR data with a computer system, the LIDAR data being received from at least one LIDAR sensor mounted to a vehicle as the vehicle moves along the pathway, receiving Global Navigation Satellite System (GNSS) data with a computer system, the GNSS data being received from at least one GNSS sensor mounted to the vehicle as the vehicle moves along the pathway, and generating a pathway map based on the LIDAR data and the GNSS data using the computer system, the pathway map including one or more segments each associated with one or more features of the pathway.

It is yet another aspect of the present disclosure to provide a method for navigating a sidewalk at least partially covered with snow. The method includes receiving LIDAR data from at least one LIDAR sensor mounted to a vehicle, determining a command to send to a control system of the vehicle based on the LIDAR data and a map including a sidewalk segment, a curb cut segment, and a grass segment, the map being previously generated based on LIDAR data of the sidewalk without snow cover, and outputting the command to the control system of the vehicle to advance the vehicle down the sidewalk.

It is still another aspect of the present disclosure to provide a system for navigating a sidewalk at least partially covered with snow. The system includes a vehicle including a control system, a LIDAR sensor coupled to the vehicle, and a controller coupled to the vehicle and the LIDAR sensor and including a memory and a processor. The controller is configured to execute instructions stored in the memory to receive LIDAR data from at the LIDAR sensor, determine a command to send to the control system based on the LIDAR data and a map including a sidewalk segment, a curb cut segment, and a grass segment, the map being previously generated based on LIDAR data of the sidewalk without snow cover, and output the command to the control system to advance the vehicle down the sidewalk.

It is a further aspect of the present disclosure to provide a method for navigating a sidewalk. The method includes receiving LIDAR data from at least one LIDAR sensor mounted to a vehicle, determining a command to send to a control system of the vehicle based on the LIDAR data and a map including a sidewalk segment, a curb cut segment, and a grass segment, the map being previously generated based on LIDAR data of the sidewalk, and outputting the command to the control system of the vehicle to advance the vehicle down the sidewalk.

The foregoing and other aspects and advantages of the present disclosure will appear from the following description. In the description, reference is made to the accompanying drawings that form a part hereof, and in which there is shown by way of illustration a preferred embodiment. This embodiment does not necessarily represent the full scope of the invention, however, and reference is therefore made to the claims and herein for interpreting the scope of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A shows a side view of an exemplary autonomous vehicle drive system.

FIG. 1B shows a front view of the autonomous vehicle drive system in FIG. 1A.

FIG. 2 shows an exemplary autonomous vehicle.

FIG. 3 shows a bird's-eye view from Google Maps of a test neighborhood.

FIG. 4 shows an exemplary intersection of a block with signs placed in the sidewalk path and a grass median.

FIG. 5A shows a substantially snow-covered sidewalk.

FIG. 5B shows a partially snow-covered sidewalk.

FIG. 6 shows an exemplary intersection in winter.

FIG. 7 shows exemplary extended Kalman filter (EKF) inputs and outputs.

FIG. 8 shows an exemplary flow for environment mapping and navigation.

FIG. 9A shows a side view of field-of-view of an exemplary LiDAR device.

FIG. 9B shows a top view of field-of-view of the exemplary LiDAR device.

FIG. 10A shows a top-down view of an exemplary complete LIDAR return data.

FIG. 10B shows a front view of an exemplary complete LIDAR return data.

FIG. 11A shows an image of a real-world sidewalk.

FIG. 11B shows an extracted sidewalk from a LIDAR scan of the real-world sidewalk in FIG. 11A.

FIG. 12A shows an image of real-world grassy areas.

FIG. 12B shows an image of extracted grassy area from a LIDAR scan of the real-world grass in FIG. 12A.

FIG. 13 shows a top down view of a LIDAR scan and section of the scan used for centerline generation.

FIG. 14A shows an exemplary process for calculating sidewalk centerlines.

FIG. 14B shows exemplary points in a path on a sidewalk in a neighborhood.

FIG. 15 shows an example of two Google Maps path alternatives between origin and destination points on the road.

FIG. 16A shows a GNSS “breadcrumb” trail of the centerlines of all the sidewalks in an area of interest (between the origin and destination) which were previously generated.

FIG. 16B shows a line drawn between exemplary points in a path on a sidewalk.

FIG. 16C shows the GNSS “breadcrumb” centerline of the sidewalk in FIG. 16A shifted from the Google Maps API GNSS road centerlines.

FIG. 17 shows an orthorectified aerial image.

FIG. 18 shows the orthorectified aerial image of FIG. 17 with manual labels.

FIG. 19 shows a 2-D point cloud of segmented sidewalk overlaid on the orthorectified image of FIG. 17.

FIG. 20 shows a sidewalk 2-D point cloud overlaid on the manually labeled orthorectified aerial image of FIG. 18.

FIG. 21 shows an aerial view of a neighborhood with areas of good GNSS reception labeled.

FIG. 22 shows a plot of GNSS coordinates converted to Universal Transverse Mercator (UTM) coordinates in meters to show how the absolute position estimate varies over a one minute period of time in a GNSS zone with good RTK reception.

FIG. 23A shows an exemplary path taken by a vehicle between a first location and a second location.

FIG. 23B shows an exemplary path taken between the first location and a fourth location.

FIG. 23C shows an exemplary path taken between the first location and a seventh location.

FIG. 24 shows a path of a vehicle traveling between a start location and an end location.

FIG. 25 shows a path of a vehicle traveling between a start location and an end location without any active GNSS input.

FIG. 26 shows an exemplary autonomous vehicle and a pile of snow.

FIG. 27 shows a process for generating a map of a paved pathway.

FIG. 28 shows a process for navigating a paved pathway.

FIG. 29 shows an example of a system for mapping and navigation in accordance with some embodiments of the systems and methods described in the present disclosure.

FIG. 30 shows an example of hardware that can be used to implement sensors, computing device, and server in accordance with some embodiments of the systems and methods described in the present disclosure.

### DETAILED DESCRIPTION

Described here are providing systems and methods for autonomous vehicles that can navigate sidewalks or other pathways using GNSS as well as LIDAR sensors. For instance, the systems and methods described in the present disclosure related to determining a location of an unmanned ground vehicle (“UGV”), mapping a pathway along which a UGV is moving, and/or navigating a UGV along a pathway. In each of these instances, LIDAR and GNSS data are measured and combined in order to provide highly accurate localization of the UGV, which enables localization and/or navigation of the UGV, in addition to mapping of the pathway using the UGV.

Simultaneous localization and mapping (SLAM) is commonly used for real-time 6 degree-of-freedom pose estimation. SLAM is either performed using vision based systems or LIDAR based systems. Both SLAM and adaptive Monte Carlo localization (AMCL) match the current perception of the environment, via LIDAR or vision, to a given environment model or map. No matter the system, both SLAM and AMCL algorithms, are prone to limitations. Since SLAM and AMCL are based on identifying landmarks in the environment, the accuracy of the pose estimation is heavily dependent on these landmarks remaining static. If the environment changes, due to snow cover or construction, SLAM and AMCL will likely fail. To make localization more robust, SLAM has been fused with other sensors such as GNSS or INS. However, these do not solve the underlying constraint of needing a fixed environment, which is not the case when there are various levels of snow on the ground.

LIDAR odometry takes into account that there is a certain amount of sensor information overlap between consecutive LIDAR scans allowing for the pose transformation of the UGV to be estimated by matching the adjacent frames. Common LIDAR odometry methods can produce adequate pose estimation results. However, these are computationally expensive and run at lower frame rates or require high powered computers. One group proposed a lightweight and ground-optimized LIDAR and mapping method (LeGO-LOAM) that is capable of real-time 6 degrees-of-freedom pose estimation on low power embedded systems. Due to its performance and low power requirements, LeGO-LOAM can be used as a localization scheme. Another group used a convolution neural network (CNN) to fuse vision, GNSS, and IMU to create a localization system for UGVs.

Localization aside, it is advantageous to be able to map and understand the environment of the UGV because the type of terrain the vehicle is moving on impacts its mobility. When traveling from pt. A to pt. B, knowing where features such as roads, sidewalks, grass, and other obstacles are located can facilitate making smart decisions and planning a path between the two points. Still another group proposed using LIDAR to create a map of drivable space in real time, however, they do not classify the different segments of the ground. Still yet another group used both LIDAR and vision systems to segment the ground and label the road as well as identify street signs. The localization schemes in both of these rely solely on GNSS and will fail in low quality reception or GNSS denied areas. An additional group performed automated and detailed sidewalk assessment using both LIDAR and vision. However, their system relies heavily on vision whose performance is highly susceptible to lighting and they do not identify other areas of the ground such as roads and grass. In a further study, yet another group focused on autonomous terrain traversability mapping, including both the mapping and classification of the ground whether the vehicle can or cannot travel on it. This may not always be desired because there are many situations where a vehicle has the physical capability to travel somewhere but it should not.

Deep learning is becoming an increasingly popular solution for object detection and semantic environment segmentation as well as road and road sign detection. However, these solutions are typically vision based (as opposed to LIDAR), require training data, and perform poorly in weather conditions such as rain and snow.

In this work, a multi-step approach to facilitate autonomous navigation by small vehicles in urban environments is proposed, allowing travel only on sidewalks and paved paths. More generally, the systems and methods described in the present disclosure enable localization and/or navigation along pathways other than sidewalks or paved paths, including trails such as hiking trails or unpaved biking trails. Similarly, the systems and methods described in the present disclosure also enable mapping of these other types of pathways.

It is desirable to have a vehicle autonomously navigate from point A on one urban block to point B on another block, crossing from one block to another only at curb cuts, and stopping when pedestrians get in the way. A small mobile platform is first manually driven along the sidewalks or other pathways to continuously record LIDAR and GNSS data when little to no snow is on the ground. The algorithm(s) described in the present disclosure can post process the data to generate a labeled traversability map. During this automated process, areas such as grass, sidewalks, stationary obstacles, roads and curb cuts are identified. The ability to classify the ground in an environment, including sidewalks, facilitates appropriate decisions during navigation such as giving the robot information where it is acceptable to travel. By differentiating between these areas using only LIDAR, the vehicle is later able to create a path for travel on suitable areas (e.g., sidewalks and/or roads), and not in other areas (e.g., grass).

An Extended Kalman Filter can be used to fuse the Lightweight and Ground-Optimized LIDAR Odometry and Mapping (LeGO-LOAM) approach with high accuracy GNSS where available, to allow for accurate localization even in areas with poor GNSS, which is often the case in cities and areas covered by tree canopy. This localization approach can be used during the data capture stage, prior to the post-processing stage when labeled segmentation is performed, and again during real time autonomous navigation. In some embodiments, the localization approach can be carried out during real time autonomous navigation using the ROS navigation stack.

There is a gap in previous research on robust localization and navigation; it has not been applied to poor weather conditions. Dynamic environments, such as snow, construction, growing vegetation, cause problems for traditional scan matching localization systems such as AMCL. By using LeGO-LOAM combined with GNSS, the robot is able to localize under many different weather conditions, including snow and rain, where other algorithms (e.g. AMCL) will likely fail. A system that allows the vehicle to autonomously plan and navigate several kilometer-long paths in urban snow covered neighborhoods is described in the present disclosure. A potential application is autonomous wheelchair navigation that could be functional under most weather conditions. Another potential application is steering assist for manually steered motorized wheelchairs in varying weather conditions.

### Vehicle Platform and Hardware

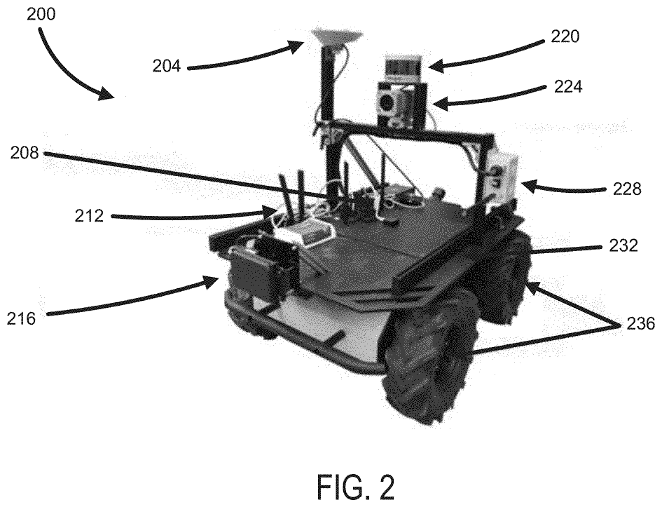

Referring now to FIG. 2, a number of sensors can be coupled to an unmanned vehicle 200. In some embodiments, the unmanned vehicle 200 can be a Husky UGV. In some embodiments, a GNSS antenna 204, an IMU sensor 208, a cell modem 212, a radar sensor 216, a LIDAR sensor 220, a camera 224, an E-Stop 228, a computational device 232, and/or wheel encoders 236 can be coupled to the unmanned vehicle 200. It is understood that the wheel encoders 236 can be optional because the unmanned vehicle 200 may be a skid-steer. Additionally, the radar 216 can be optional because in some embodiments, the GNSS antenna 204, the IMU sensor 208, and the LIDAR sensor 220 can be used to navigate the unmanned vehicle 200.

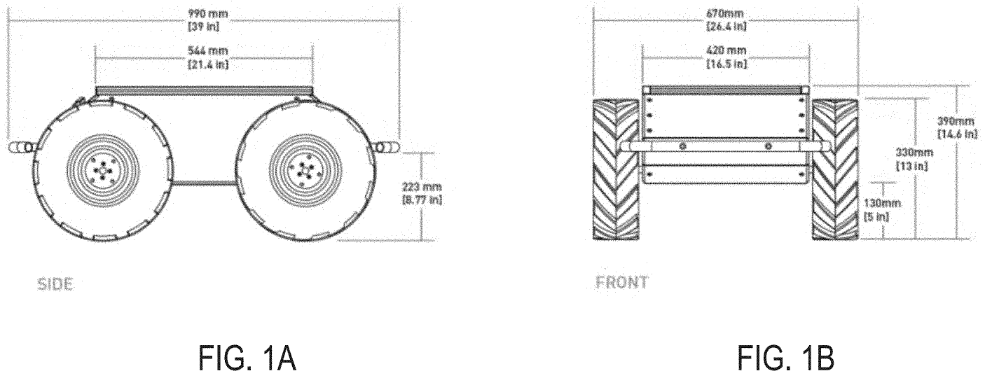

The Husky UGV platform from Clearpath Robotics was used as a base vehicle for mounting hardware and sensors in a number of real world studies for the proposed LIDAR and GNSS based system. It is understood that other platforms can be used as base vehicles in autonomous vehicle systems in accordance with this disclosure. The Husky comes equipped with four 330 mm diameter wheels. In some configurations, the Husky can include rotary encoders; however, the rotary recorders are not necessary for localization, positioning, and/or navigation using the techniques described in the present disclosure. Certain vehicles, such as skid-steers, may not be able to use rotary encoders for positioning, and the Extended Kalman Filter that fuses LeGO-LOAM with high accuracy GNSS can provide localization and/or positioning for skid-steers such as the Husky. That is, the methods described in the present disclosure are capable of determining a location of a UGV without the need of rotary encoder data, which measures the angular position and/or motion of the wheels on the UGV. This is advantageous for UGVs that implement tracks or skid-steers where rotary encoder data are not measured or are not reliably measurable. The vehicle has external dimensions of 990×670×390 mm and has a max payload of 75 Kg with a top speed of 1 m/s. In the center of the vehicle is a weatherproof storage area where the electronics are stored, such as a computer and a WIFI router. Dimensions of the Husky vehicle can be seen in FIG. 1.

The on-board computer in the Husky can be a Mini-ITX single board computer with 3.6 GHz Intel i7-770 processor, 16 GB DDR4-2400 RAM, and a 512 GB SSD. The sensors mounted on the vehicle for testing included a high accuracy Trimble GNSS antenna and RTK receiver, a Velodyne VLP-16 LIDAR, and a Phidgets IMU. The Real-time Kinematic (RTK) GNSS receiver and antenna exhibits sub-centimeter accuracy in GNSS areas with good reception. The Velodyne LIDAR (VLP-16) has 16 channels with a vertical field of view of −15° to +15° with each channel separated by 2° horizontally. There are 1800 LIDAR points returned for each channel in the LIDAR which has a maximum measurement range of 100 m. The LIDAR returns up to 300,000 points/second. The Phidgets IMU has a 3-axis accelerometer, gyroscope, and compass. The hardware mounted on the Husky platform can include the GNSS antenna 204, the IMU sensor 208, the cell modem 212, the radar sensor 216, the LIDAR sensor 220, the camera 224, the E-Stop 228, the computational device 232, and/or the wheel encoders 236 in FIG. 2.

The Husky UGV is a skid-steer platform (also called a differential drive platform), meaning the wheels on the right side of the vehicle rotate in the same direction and at the same velocity as each other and the same can be stated about the wheels on the left side. The set of wheels on one side spin independently of the wheels on the other side of the vehicle. Differential drive kinematics allows the vehicle to rotate about its center without having to travel forward or backward. This varies from Ackerman steering in which one axle of the vehicle allows the wheels to rotate and on the other axle the wheels are fixed, which is common in many vehicles today.

As described above, the Extended Kalman Filter that fuses LeGO-LOAM with high accuracy GNSS can provide localization and/or positioning for skid-steer platforms. For skid-steer platforms, the wheels commonly slip during vehicle movement, and rotary encoders cannot be relied on for accurate positioning due to wheel slip. The Extended Kalman Filter can accurately localize skid-steer platforms because it relies on LIDAR and GNSS sensors rather than rotary encoders as inputs.

In some embodiments, the vehicle computer runs the Robot Operating System (ROS) for fusion of multiple sensor readings and facilitates implementation of custom control and software algorithms. ROS is a “collection of tools, libraries, and conventions that aim to simplify the task of creating complex and robust robot behavior across a wide variety of robotic platforms”. ROS is a powerful tool that allows researchers around the world to collaborate and build off previous work in an easy and efficient manner. Clearpath uses ROS to control all of its vehicles and supports its drivers through ROS. ROS allows the sensors (GNSS, LIDAR, IMU) to be fused together in order to localize and create a labeled map, as well as send velocity commands to the motors while traveling.

A cell modem provides internet access to the vehicle and allows for the GNSS system to wirelessly receive position corrections. An E-Stop receiver is mounted on the outside of the vehicle and allows for remotely pausing the system if needed.

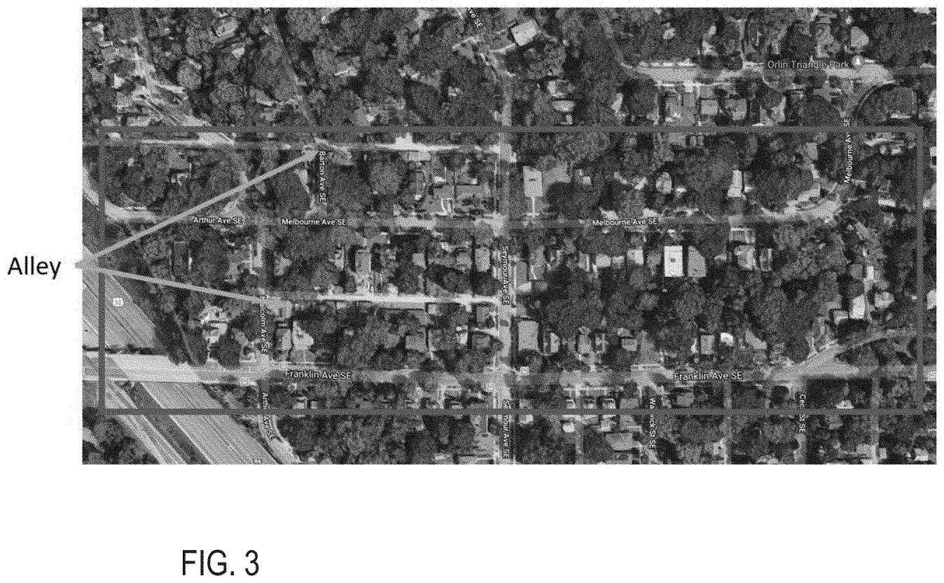

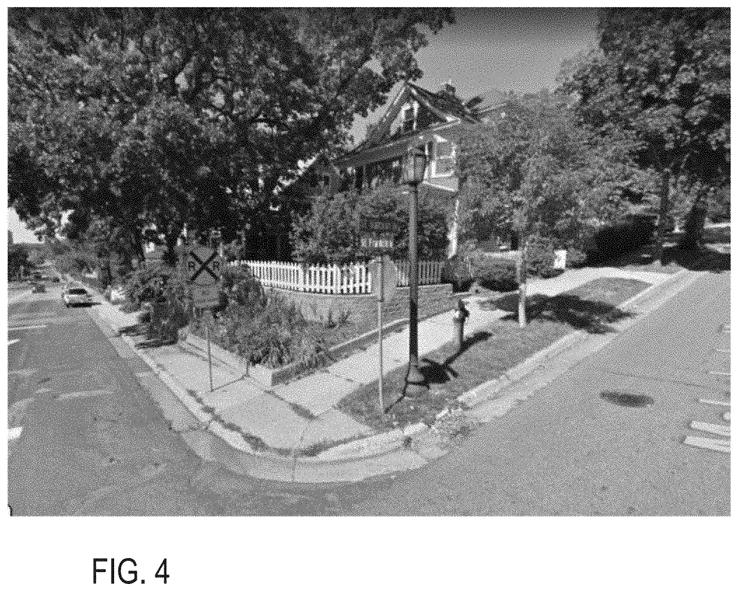

Since one goal is to generate a labeled map of an urban sidewalk environment and autonomously localize and travel between two points, a neighborhood was desired that had many different characteristics that a vehicle might encounter in the urban world. A neighborhood near the University of Minnesota—Twin Cities campus was selected because it satisfied many characteristics which were desired for testing. A table of the desired characteristics can be seen in Table 1 below and an aerial view of the location obtained from Google Maps can be seen in FIG. 3. An image showing some unique aspects of the neighborhood can be seen in FIG. 4.

TABLE 1

| Desired Characteristic | Present |
|---|---|
| sidewalks with a boulevard of trees between it and the curb | Yes |
| sidewalks with no boulevard between it and the curb | Yes |
| sidewalks with curb cuts or no curb cuts at the intersections | Yes |
| sidewalks that include driveways | Yes |
| sidewalk curb cuts that are perpendicular to the street | Yes |
| sidewalks located on non-orthogonal streets | Yes |
| sidewalk curb cuts at the intersection corners that are wide | Yes |
| enough for entry into either of the two adjacent streets | |
| sidewalks with objects located in the sidewalk, for example | Yes, |
| parking meters, trees, bike racks, which are permanent | street |
| | signs |
| poor quality sidewalks | Mostly No, |
| | some poor |
| | quality |
| | sidewalks |
| sidewalks with nonpermanent objects, such as bicycles | No |
| obstructing forward motion. This may also include a barrier | |
| due to a construction zone ahead or a pile of snow during | |
| the winter. | |
| sidewalks that just end with grass ahead | No |
| sidewalks with grass or bushes on either side or grass/ | Yes |
| bushes only on one side | |
| sidewalks include walkways or stairs to the front door of | Yes |
| adjacent homes | |
| sidewalks extend directly from a building (e.g., a store | Yes |
| front) to the curb | |
| an alley with no sidewalks | Yes |

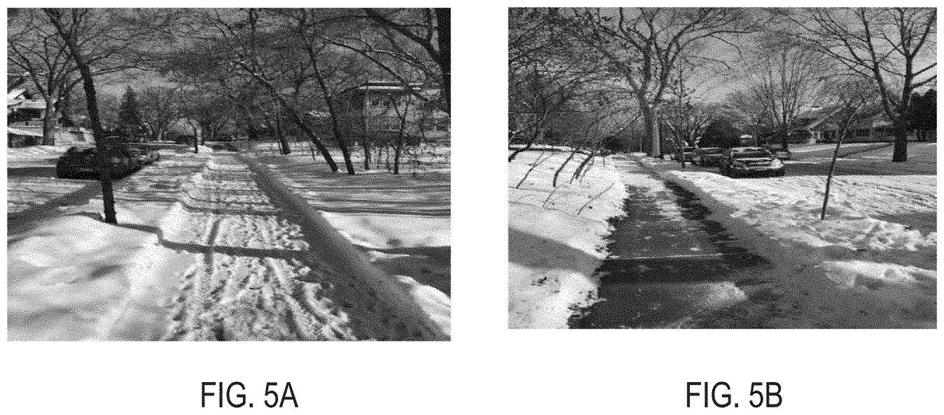

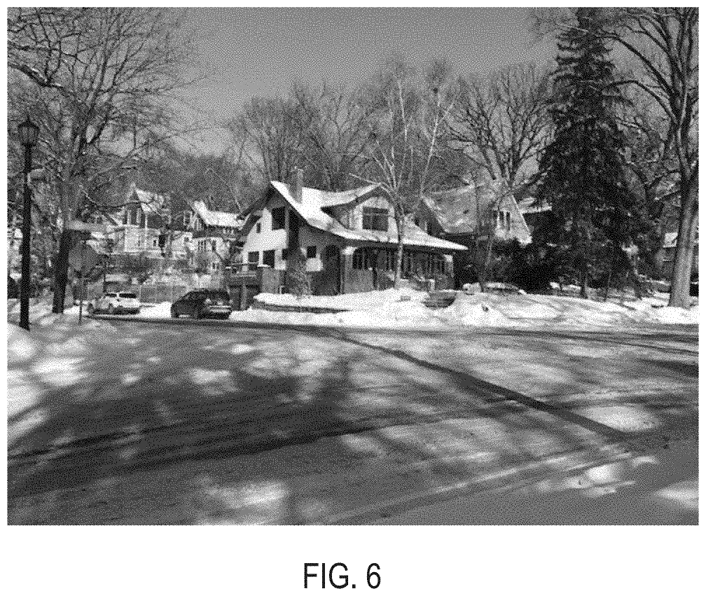

Since a major focus of this disclosure is the ability to travel in snow covered terrain, images showing the testing environment in the winter are shown below in FIG. 5 and FIG. 6.

### Localization Technique

In this disclosure, for simplicity, a planar environment is assumed; however, it will be appreciated that the techniques described in the present disclosure can be extended to other environments as desired. This means that the vehicles pose can be satisfied by knowing its X, Y position as well as its yaw (i.e., heading). In order to autonomously navigate between two points, it is advantageous if the vehicle is able to accurately localize in the environment. The localization scheme proposed in this research uses an Extended Kalman Filter to fuse together high accuracy GNSS, LIDAR Odometry, and IMU data. The GNSS system allows for accurate global localization when there is good enough reception, such as in road intersections and clearings in the tree canopy. Global localization allows the vehicle to know where it is in the world, in terms of latitude and longitude. This is advantageous when plotting a path between two global points in the world as it allows for the definition of positions in terms of latitude and longitude.

LIDAR Odometry (LeGO-LOAM) provides dead-reckoning localization in low quality GNSS areas. These areas include locations under tree canopy, indoors, and areas surrounded by buildings. The LIDAR odometry provides localization relative to the most recent accurate GNSS position. The IMU provides an initial yaw measurement of the vehicle upon startup.

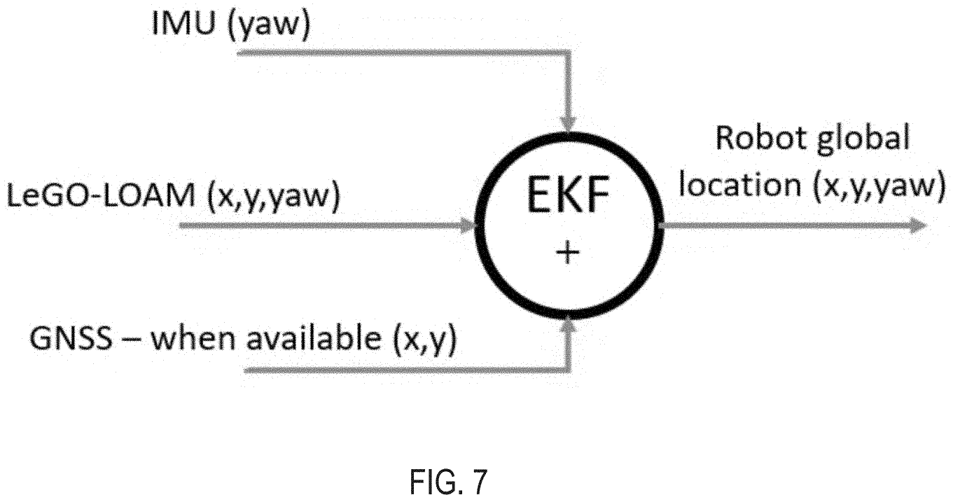

The extended Kalman filter (EKF) used is provided by the ROS package robot_localization. Robot_localization is an open source collection of state estimation nodes which implement nonlinear state estimation for vehicles. The EKF uses an “omnidirectional motion model to project the state forward in time, and corrects that projected estimate using perceived sensor data”. The inputs and outputs of the EKF, which are constrained to a planar environment, can be seen in FIG. 7.

The EKF process provided is a nonlinear dynamic system, with

xₖ=ƒ(xₖ−1)+wₖ−1

where xₖ is the robot's state at time k, ƒ( ) is the nonlinear state transition function, and wₖ₋₁ is the normally distributed process noise. Without any assumptions, the state vector x is 12-dimensional which includes the 3D pose and orientation of the vehicle, as well as the respective velocities of the pose and orientation. In some embodiments described in the present disclosure, a planar environment can be assumed, which reduces the number of dimensions down to six. When the EKF receives a measurement, it is in the form

zₖ=h(xₖ)+vₖ

where zₖ is the input measurement at time k, h is the nonlinear sensor model mapping the state into measurement space, and vₖ is the measurement noise. The initial step of the EKF is called a prediction step that projects the current state of the vehicle and its respective error covariance forward in time:

xₖ=ƒ(xₖ₋₁)

\hat{P}ₖ=FPₖ₋₁F^{T}+Q

where ƒ( ) is a 3D kinematic model derived from Newtonian mechanics, P is the estimate error covariance, F is the Jacobian of ƒ( ), and Q is the process noise covariance. Finally, a correction step is carried out to update the state vector and covariance matrix.

### GNSS Specifics

ROS converts the latitude and longitude coordinates from the receiver to X and Y coordinates in the vehicle frame via a provided navsat_transform node in the ROS navigation stack. The navsat_transform node allows for quick conversions from GNSS coordinates to cartesian coordinates in the vehicle frame. It is assumed that the vehicle starts in a high accuracy GNSS location to ensure the vehicle gets a good initial global position estimate. However, if a high accuracy GNSS location is not available as a starting point, an equivalent LIDAR-based location can be used as a starting point, and the location of the vehicle in latitude and longitude coordinates can be determined from the LIDAR-based location. The first high accuracy GNSS location the vehicle receives is set as the (0,0) XY position of the vehicle. Any subsequent high accuracy GNSS receptions positions are considered relative to this initial start point. A covariance matrix is calculated automatically in ROS based on the quality of GNSS reception. Before feeding the GNSS data into the EKF, coordinates above a certain covariance threshold are filtered out. This stops low accuracy GNSS positions from negatively affecting the localization in the EKF. Tests were performed with only low accuracy GNSS and the results will be discussed in below.

### LIDAR Odometry Specifics

LIDAR odometry provides localization estimates relative to a specific pose. That is, ΔX, ΔY, and Δyaw are estimated from the starting pose of the vehicle given by the GNSS and IMU. For simplicity, a static covariance of 0.01 is set for each pose estimation for LIDAR Odometry before it is fed into the EKF. The LIDAR odometry in an urban environment can travel 500 meters before the drift reaches above 0.5 meters. LIDAR odometry needs many distinct features for an accurate localization estimate, the fewer the features, the faster the drift will accumulate.

### IMU Specifics

The heading of the vehicle can be used to help fully define its pose in a planar environment. Since the initial pose X and Y is given from the GNSS, an IMU with a magnetometer is used get the initial yaw of the vehicle. LIDAR Odometry is then used to estimate the Δyaw from the initial start position.

### Mapping and Navigation Procedure

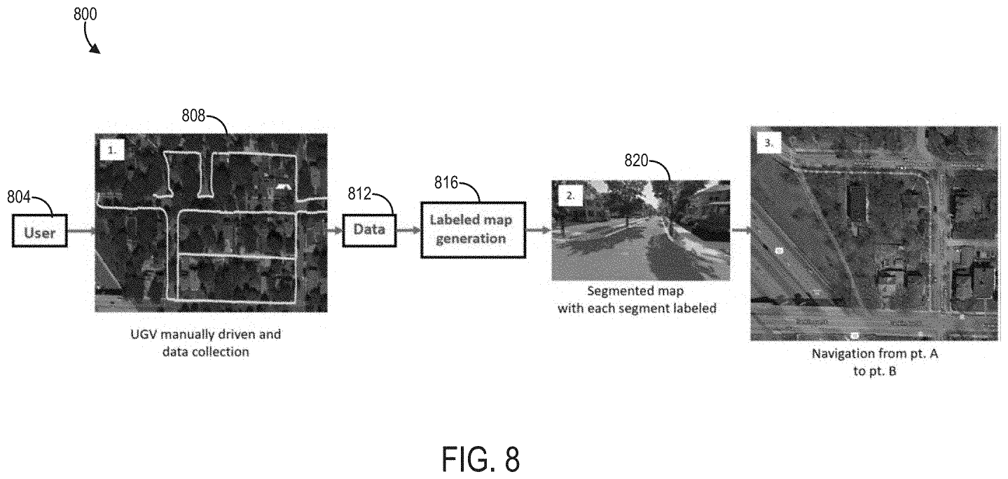

This research proposes a multistep approach to mapping and classifying the environment that the vehicle is traveling in. These steps include data collection, automated post-processing of data, and autonomous navigation between points while traveling only on sidewalks, or other pathways, and intersections. An overview of the process flow 800 can be seen in FIG. 8. The post-processing step classifies LIDAR data into regions such as grass, sidewalks, roads, and obstacles and generates a labeled segmented map. The details for these steps are described below.

### Data Collection While Manually Steering Vehicle

The first step towards generating a classified map of the region of interest is collecting the data 808 that will be processed to generate such a map. A user 804 steers the vehicle manually via commands from a joystick controller or arrows on a keyboard. The user 804 can steer the robot along all the sidewalks, alleys, or other paved or unpaved pathways that they want the vehicle to be able to travel on autonomously in the future. Preferably, the vehicle is driven through all of the potential destinations to which one may want the vehicle to navigate in the future, such as relevant building entrances or bus stops. This data collection is also preferably done when there is no snow on the ground, which can facilitate better segmentation of the environment, since snow can easily cover many distinctive features of objects.

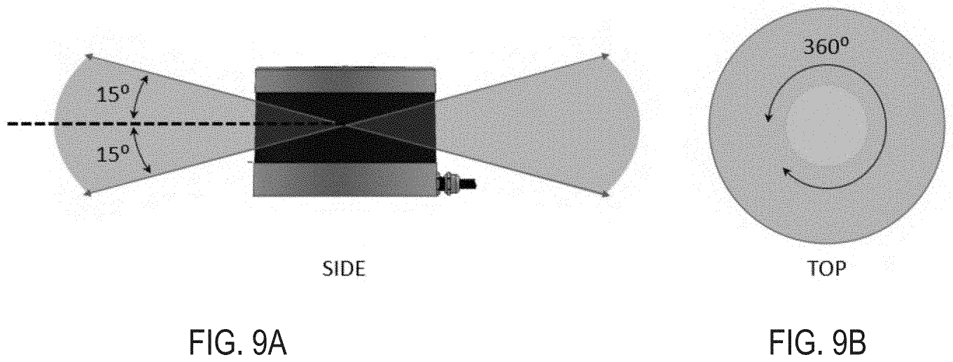

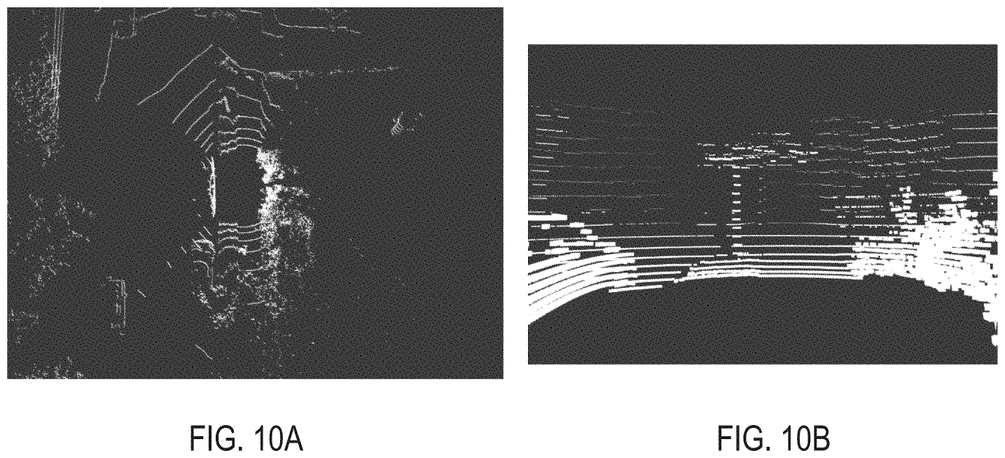

The data 812 collected at 808 comes from the LIDAR, GNSS, and IMU. The LIDAR data is three-dimensional information about the environment around the vehicle. The field-of-view (FOV) of the LIDAR can be seen in FIG. 9 and an example of the 3-D point-cloud returned by the LIDAR can be seen in FIGS. 10A and 10B, which illustrate a top-down view of an exemplary complete LIDAR return data and a front view of the exemplary complete LIDAR return data, respectively.

The GNSS data is also collected in order to identify where GNSS high-accuracy reception is available in the neighborhood. This data can also be used when generating a path. The IMU data allows for the initial yaw pose estimation. During the mapping procedure, the vehicle pose is identified using the localization scheme described above.

Despite previous attempts to autonomously explore urban environments, there is a lack of research in autonomous exploration in an urban environment that adheres to socially acceptable means of exploration, such as only using sidewalks and avoiding driving over grass or other people's lawns. In addition to this, autonomously exploring a neighborhood may take much longer than if it was explored without the assistance of a user steering the vehicle. As a result, in some implementations the use of autonomous exploration may not be desired, and instead the vehicle can be manually steered to collect the data. Alternatively, in other embodiments, autonomous exploration can be used. In some embodiments, the vehicle can be configured to follow a walking person and collect the data. In some embodiments, the vehicle can be pushed and/or pulled by a walking person and/or pulled by another vehicle (e.g., a bicycle, motorized wheelchair, etc.) and collect the data. If the vehicle is pulled, it is important that the front view of the sidewalk by the LIDAR sensor not be obstructed.

The second step of the flow 800 is to automatically analyze the data and generate 816 a segmented and labeled map 820 of the area of interest from the LIDAR point cloud. The LIDAR outputs approximately 30,000 points per frame and runs at 10 Hz which results in 300,000 3-D points per second. Each of these points represent the distance to a point on the surface of objects in the environment that the vehicle is in. The LIDAR data points are sent through a custom algorithm that allows for the classification of the points into sidewalks, roads, grass, curbs and curb cuts, and obstacles. Obstacles are defined as trees, bike racks, stairs, etc. These types of objects can be broadly classified together because when traveling between two points, the vehicle just needs to know enough to avoid these objects and doesn't need to know explicitly the type of object it is. For example, knowing the distinction between grass and sidewalk may be more relevant than knowing the difference between a lamp-post and a tree. In many applications, it is desirable for the robot to drive on sidewalks and not on grass, so being able to distinguish between grass and sidewalk is advantageous. However, both the tree and lamp-post represent an object that should be avoided; distinguishing between a tree and lamp-post is not as relevant as their shape. An outline of how the vehicle classifies the environment can be seen in Algorithm 1.

In Algorithm 1 described below, the slope is taken between two column-wise points. In terms of the LIDAR point cloud, two-column wise points will be in separate channels of the LIDAR in the vertical direction. The grade of the road, in reference to the road curvature, is defined as the magnitude of the slope as it rises and falls along its width. Objects such as stairs and retaining walls will fall into the category of obstacle in this algorithm.

Algorithm 1: LIDAR Classification into grass, road,
sidewalk, and obstacles

```
Result: Segmentation and Classification of Environment using
only LiDAR
Loop through all LIDAR input points;
while valid point received do
  | Calculate slope between two column-wise (vertical) points;
  | ΔX = X1 − X0
  | ΔY = Y1 − Y0
  | ΔZ = Z1 − Z0
  | θ = atan2(ΔZ, \sqrt{ΔX² + ΔY²})
  | if θ < θₜₕᵣₑₛₕ then
  | | Calculate std. dev. (roughness) of n consecutive LIDAR points;
  | |  $s = \sqrt{\frac{1}{N - 1} {\sum }_{i = 1}^{N} {( {x}_{i} - \overline{x} )}^{2}}$
  | | if s > sₜₕᵣₑₛₕ then
  | |  | The LIDAR point is Grass;
  | | else
  | |  | Point may be road or sidewalk;
  | |  | Calculate curvature of consecutive points;
  | |  |  $k = \vert \frac{dT}{dS} \vert$
  | |  | Calculate presence of curbs (sharp elevation changes);
  | |  | curb = ΔZ > zₜₕᵣₑₛₕ
  | |  | if curvature meets expected grade AND presence of
  | |  | curb then
  | |  |  | The LIDAR point is Road;
  | |  | end
  | |  | if no curvature then
  | |  |  | The LIDAR point is Sidewalk;
  | |  | end
  | | end
  | else
  | | The LIDAR point is an obstacle;
  | end
end
```

### Pathway Segmentation

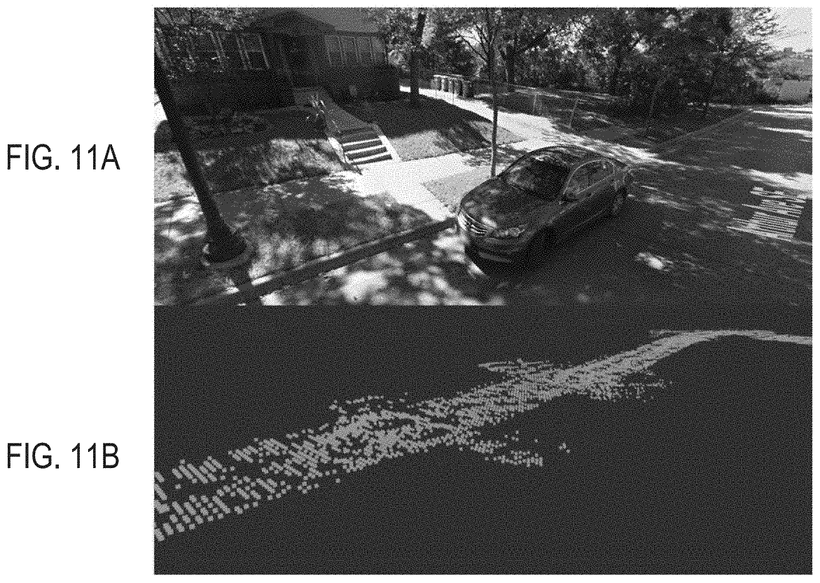

Determining where the sidewalk or other pathway is in the environment is a general aspect of map generation 816. It is used to give the vehicle the ability to travel using the pathway and not the surrounding environment, which may otherwise be traversable. For instance, the map may be used to travel on a sidewalk and not on the surrounding grass. A notable characteristic about sidewalks or other paved pathways is that a quality sidewalk (meaning without major holes, cracks, or tree roots) is smooth and flat. This means the LIDAR points falling on the sidewalk should return data that has similar elevation with little variation between consecutive points. Sidewalks are also typically surrounded by grass, curbs, walls, or vegetation which cause a discrete jump in the LIDAR scan. Taking these characteristics into consideration, the sidewalk can be extracted from the raw LIDAR scan. An example of the sidewalk LIDAR classification result can be seen in FIGS. 11A-B. FIG. 11A shows an image of a real-world sidewalk. FIG. 11B shows an extracted sidewalk from a LIDAR scan of the real-world sidewalk in FIG. 11A. It is understood that the extracted sidewalk in FIG. 11B is not depicted at the same scale as the real-world sidewalk in FIG. 11A. Similar features can also be determined for other paved and unpaved pathways, which may have adjacent structures or features that can be identified in LIDAR data and segmented for the purposes of generating the pathway map.

### Road Segmentation

Roads in urban environments are similar to sidewalks in that they are typically smooth. However, to differentiate them from sidewalks, roads also have a distinct cross slope to them. The cross slope is designed into roads so that the highest point of the road is in the center which causes water to drain from the road surface to the street gutters. Urban roads are also often surrounded by curbs, meaning the LIDAR scan (when the robot is on a sidewalk) will see an elevation jump from the sidewalk down to the road, the road back up to the sidewalk, or both.

### Grass Segmentation

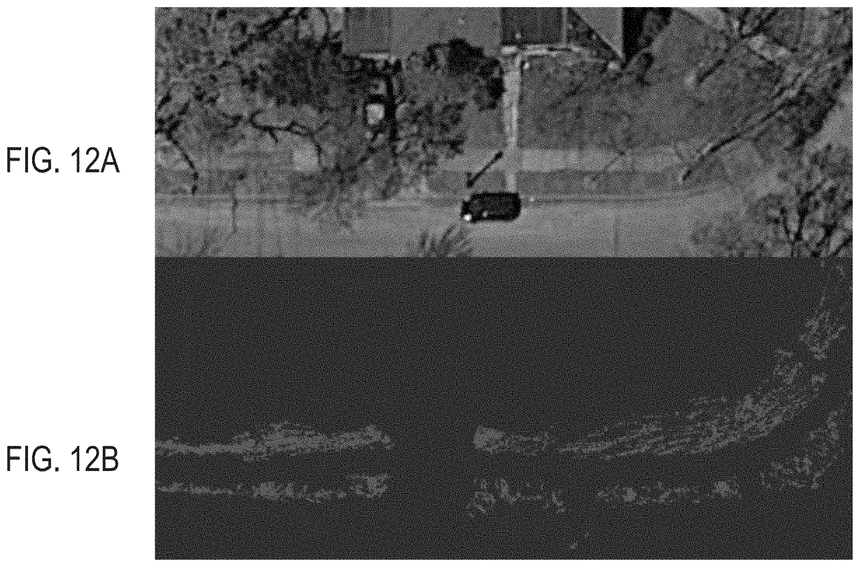

Unlike sidewalks and roads, LIDAR points that fall on grass are noisy. The blades of grass create a high standard deviation of consecutive points that allow for easy classification in comparison to roads and sidewalks. An example of the road LIDAR classification can be seen in FIGS. 12A-B.

FIG. 12A shows an image of real-world grassy area including grass. FIG. 12B shows an image of extracted grass from a LIDAR scan of the real-world grassy areas in FIG. 12A. It is understood that the extracted grass in FIG. 12B is not depicted at the same scale as the real-world grassy area in FIG. 12A. The top section of grass in FIG. 12B shows a thinner strip of grass than is apparent in the aerial image in FIG. 12A. This is because there is a steep slope in these yards that is not shown in the aerial image, as a result the algorithm may not classify the LIDAR points as grass when the slope is too steep.

### Curb and Curb cut Segmentation

Curbs are associated with the break in elevation between the road and sidewalk or grass median. In a typical urban neighborhood, sidewalks are positioned higher in elevation than roads. There are two common scenarios, the first one is where there is a sidewalk, a curb, then a road. The second being where there is sidewalk then a grass median, then the curb, then the road. Curb cuts are detected when the sidewalk merges with the road.

### Sidewalk GNSS Centerline Generation

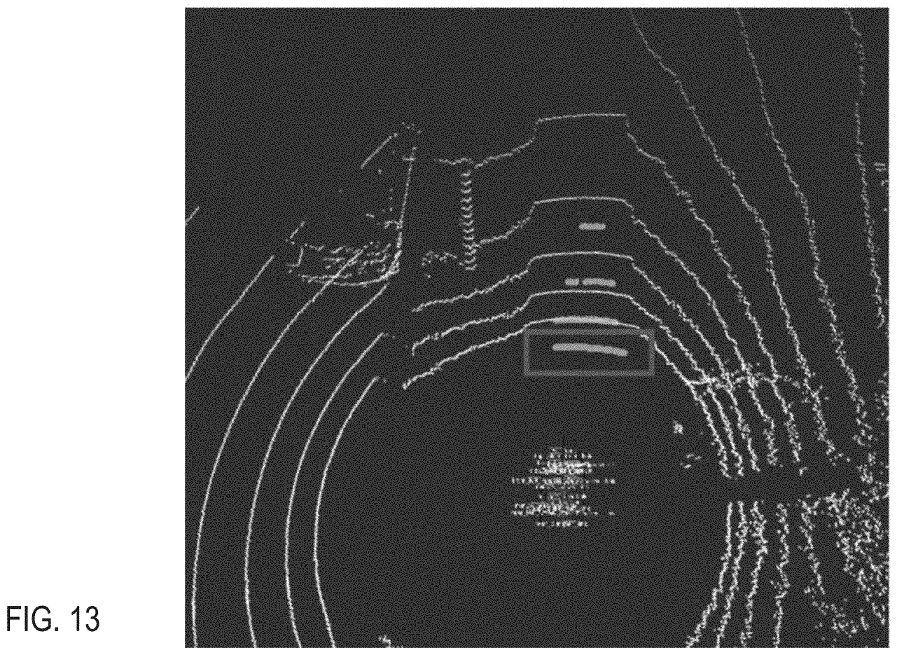

For the robot to travel only on sidewalks or other pathways, the centerlines of the sidewalks or other pathways can be determined and used to generate a path using the sidewalks or other pathways. More specifically, the GNSS coordinates of the sidewalk or other pathway centerline are desired. The first step to find the pathway centerline is to extract the sidewalk or other pathway directly in front of the robot from the first (or the lowest in elevation) channel of the LIDAR, as shown in FIG. 13.

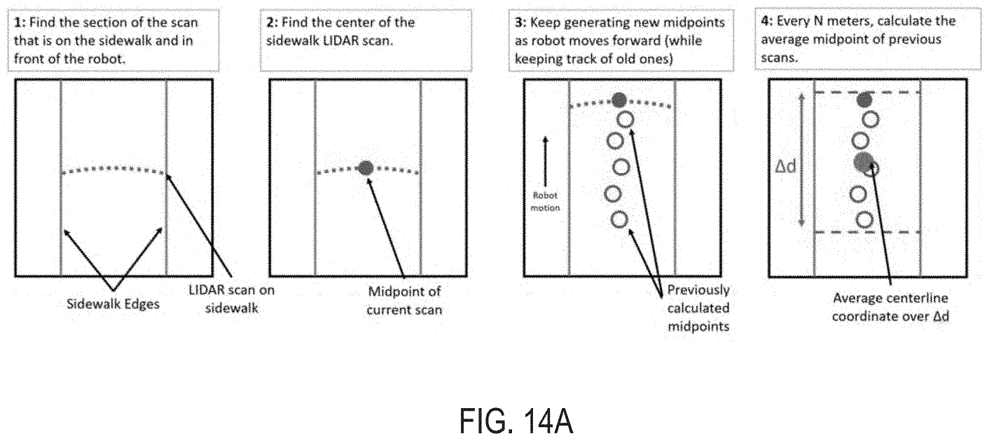

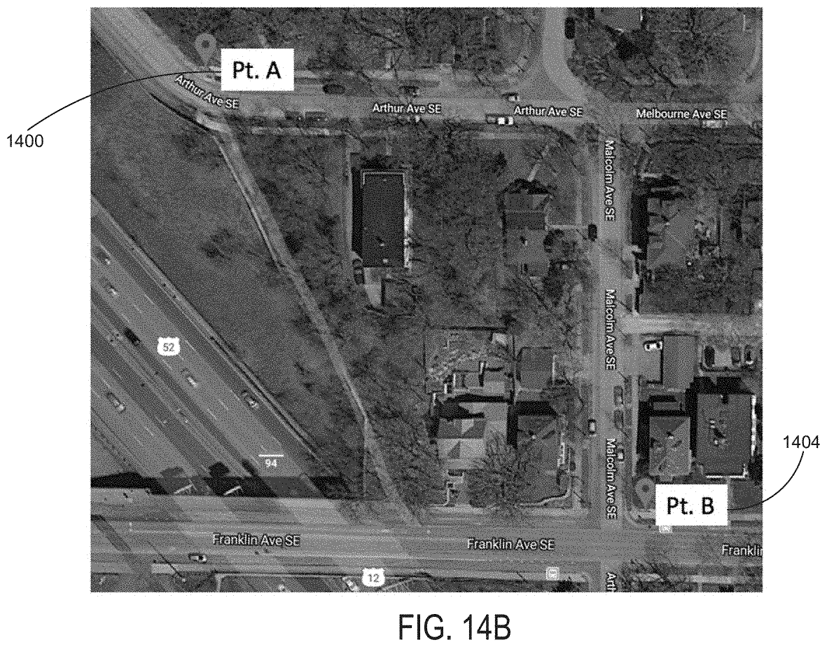

The midpoint of this sidewalk scan is archived, and a new centerline point is found as the robot moves forward. In some embodiments, every one meter, all the centerline points that were archived for the past 1 meter are all averaged and the X and Y points (which are the output of the EKF), which are relative to the starting pose, are saved as the centerline for that section of sidewalk. In some embodiments, centerline points can be generated for sections of lengths other than one meter (e.g., a half meter, two meters, etc.). This point is then converted using the ROS navigation stack to a latitude and longitude coordinate. A visual of this process can be seen in FIG. 14. In some embodiments, aspects of the sidewalk other than the midpoint can be captured and/or analyzed to generate latitude and longitude coordinates. For example, the edges of the sidewalk may be mapped to latitude and longitude coordinates.

Locations with High Accuracy GNSS

Areas with good GNSS reception in the neighborhood are recorded and mapped during the initial data collection. This is relevant information for several reasons. If the vehicle localization using LIDAR odometry were to drift too much while it is traveling, one can divert to the nearest area with good GNSS reception in order to zero its error. During path planning, a path can also be generated so that if the vehicle knows it will be traveling for too long in an area relying solely on LIDAR Odometry and an unacceptable amount of drift will likely occur, the path can be modified to navigate to a known area with good GNSS reception to ‘check-in’ and reduce the localization error, and then continue on the rest of the path to the final destination. However, this functionality is not used in this research because in the testing environment all paths currently generated happen to cross through a high accuracy GNSS zone, such as those located at identified intersections.

### Path Planning and Navigation

Now that the environment has been mapped, the system knows where there is grass, sidewalks, roads, curb cuts, and obstacles. This information is used to create a path from pt. A to pt. B using only sidewalks and curb cuts to cross intersections. Consider an objective to determine a path along sidewalks from an origin 1400 to a destination 1404 as seen in FIG. 14B The sidewalk centerline points and Google Maps Application Programming Interface (API) are then used to plan the path in an efficient way.

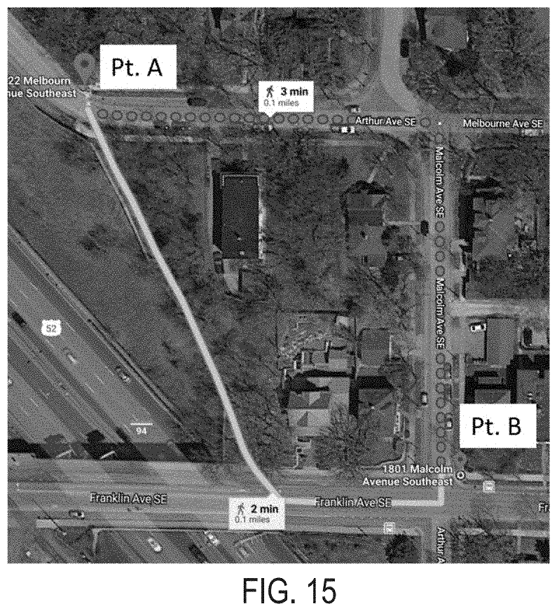

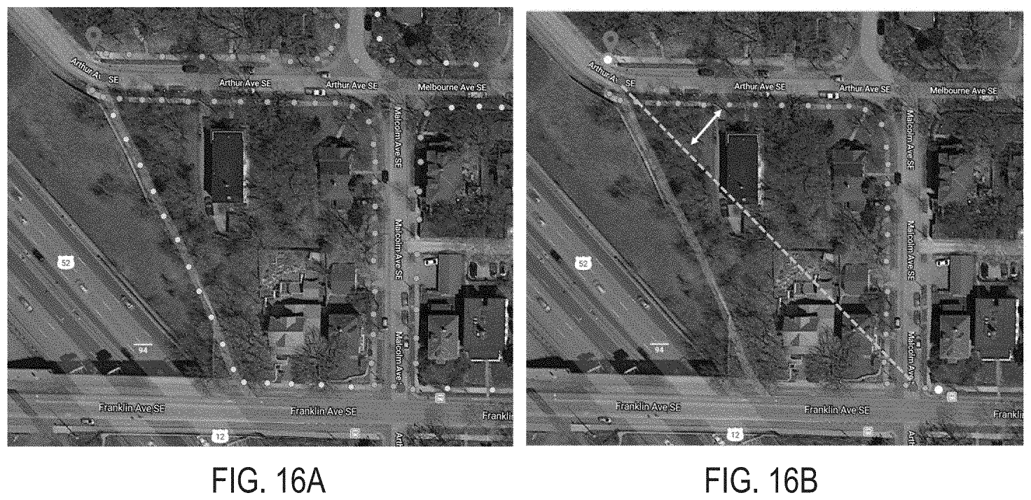

The Google Maps API is used to plot an initial GNSS coordinate path between the origin and destination positions. An advantage of using the Google Maps API is the capability to use landmarks such as street names or addresses directly instead of knowing exact coordinates of the locations to which you want the vehicle to travel. However, Google Maps API will plot a GNSS ‘breadcrumb’ path that lies on the road centerlines and not on the sidewalks. A visual of example paths plotted via Google Maps can be seen in FIG. 15. It is noted that both paths were generated by Google Maps for pedestrians, yet the blue dotted path follows the road centerline and the solid path follows a path through a park/forest and then diverts into the middle of the road. To generate a GNSS breadcrumb path on a sidewalk, the road path can be shifted to the sidewalk map. Google Maps can also provide alternative paths not on roads (e.g. bike trails). In this case, no shifting may be required.

The road centerline GNSS points can be modified to handle sidewalks and can be shifted over to the appropriate sidewalk centerlines. To apply corrections to the initial path, generated by the Google Maps API, the path is overlaid onto the previously generated segmented map. The GNSS coordinates from the road are shifted to the sidewalk centerlines and curb cuts. Algorithm 2 (described below) will find the closest sidewalk/curb cut entry/departure points to the initial path determined with the road centerlines.

Algorithm Sidewalk Path Generation

Result: Path from pt. A to pt. B using only sidewalks and intersections
Get initial path between points from. Google Maps API;
while All points along path not refined do

| \| | Overlay Google Maps path onto segmented map; | |
|---|---|---|
| \| | Plot straight line between pt. A and pt. B; | |
| \| | Calculate closest distance from center-line to all sidewalk points ; | |
| \| | Calculate sum of distances for all strings of sidewalk points; | |
| \| | if Sidewalk center-line GNSS points closer to line then | |
| \| | \| | Favorable sidewalk GNSS points for path; |
| \| | else | |
| \| | \| | Reject sidewalk GNSS point path; |

| | |
|---|---|
| \| | end |
| \| | Correct and shift Google Maps GNSS coordinates from road to sidewalks ; |

end

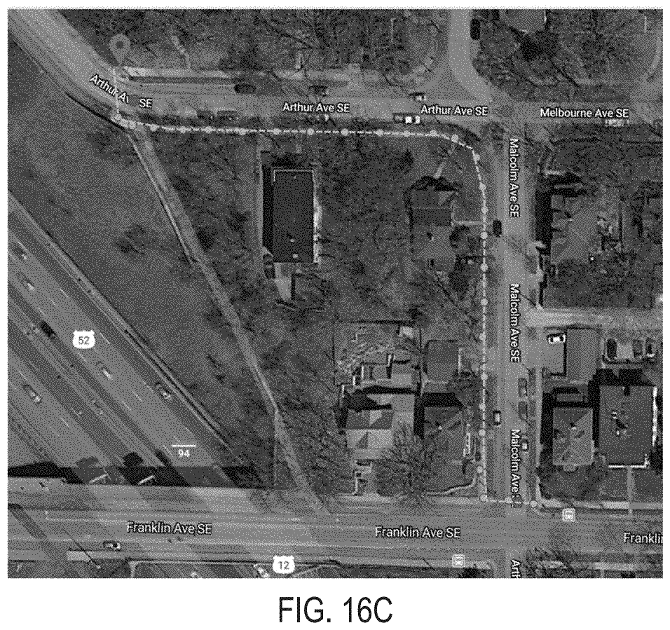

Given a destination coordinate, the vehicle will likely have several different valid path options to take to travel to the destination. An example of all the possible sidewalks determined previously in the area of interest is shown in FIG. 16A. In most instances, the goal ofthe path planner is to take the shortest route possible. In order to reduce the number of paths down to one, a straight line is projected from pt. A to pt. B as seen in FIG. 16B. This line helps pick one side of the street to favor over the other (if needed). The distances between all the possible sidewalk centerline markers and the line drawn between pt. A and pt. B are calculated and the sum of these distances for the different path options are found. The set of sidewalk centerlines that are closest to the line provide a single solution for the path between the points. This path is shown in FIG. 16C.

Now that a path has been generated between two points using only sidewalks and curb cuts at intersections, the vehicle has the ability to autonomously navigate the path using the ROS navigation stack. The ROS Navigation stack allows for path following by generating the velocity and heading used by the robot to follow and stay on the path. The velocity and heading can then be converted to motor commands to control the wheels on the Husky via a ROS package provided by Clearpath Robotics. The ROS Navigation stack also provides functionalities such as obstacle avoidance using LIDAR scans to avoid people and pets while traveling.

While the robot is following the ‘breadcrumb’ path, the vehicle's pose is identified using the localization scheme of combining high accuracy GNSS and LIDAR Odometry described above. The path planner may only allow the vehicle to cross the road at intersections, or the path planner may allow the vehicle to cross the road using other curb cuts such as driveways.

### Results

In order to quantify the accuracy of the system and see how well it performed, the results are divided into to two sections: the mapping results and the localization results.

### Evaluation of Segmented Map

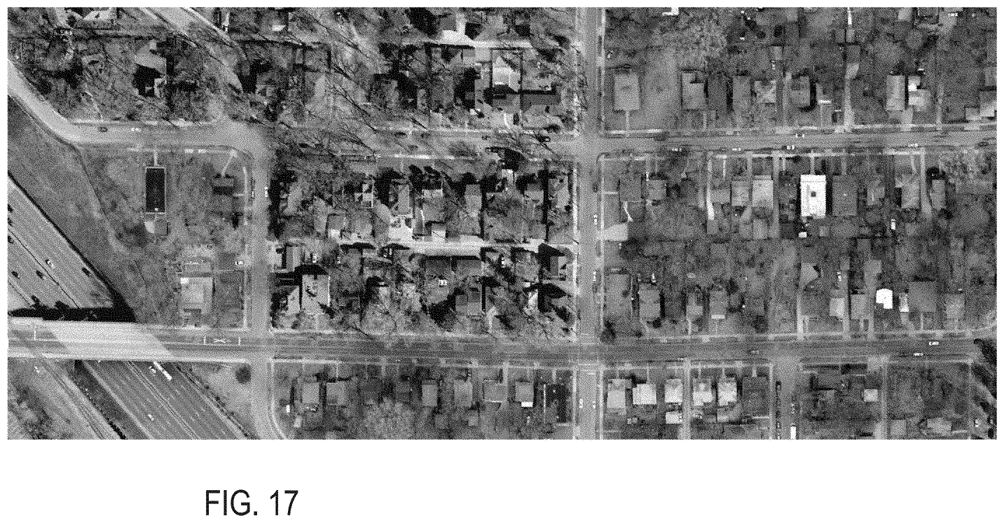

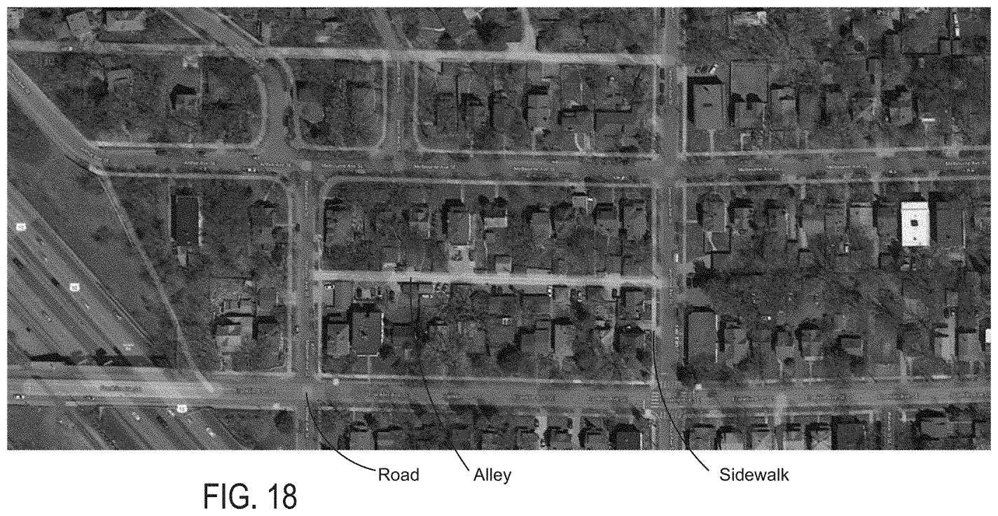

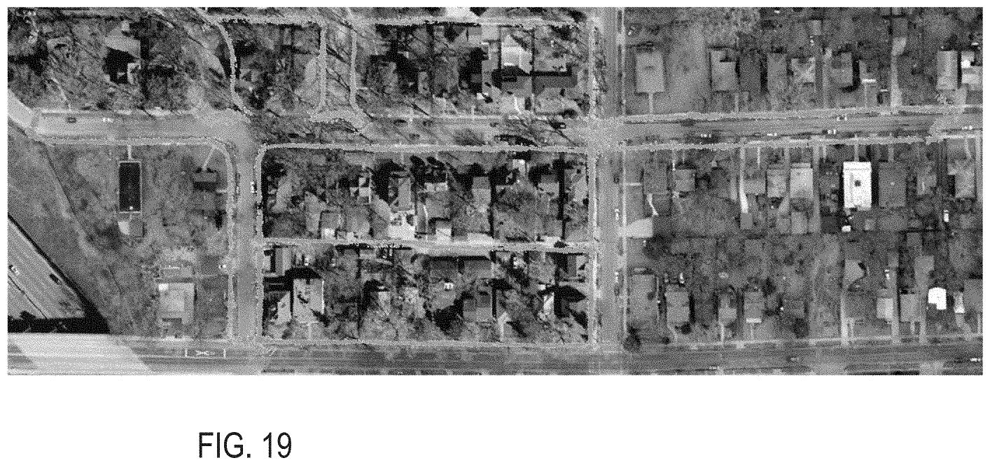

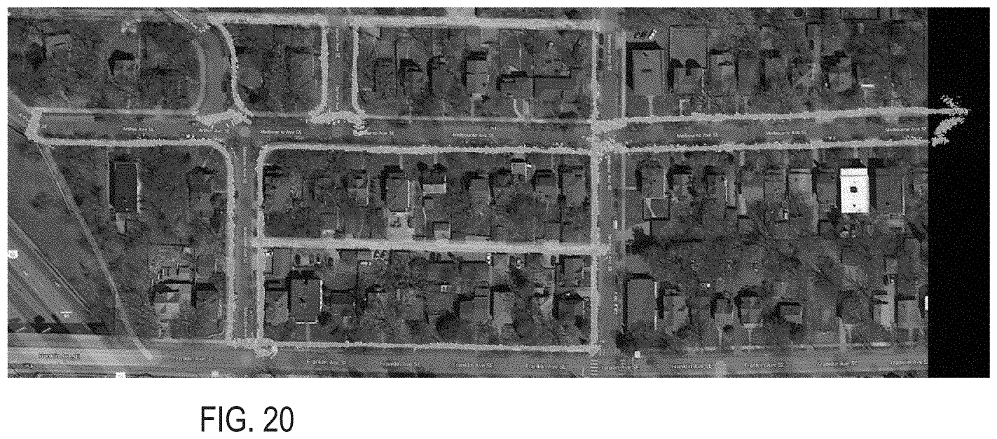

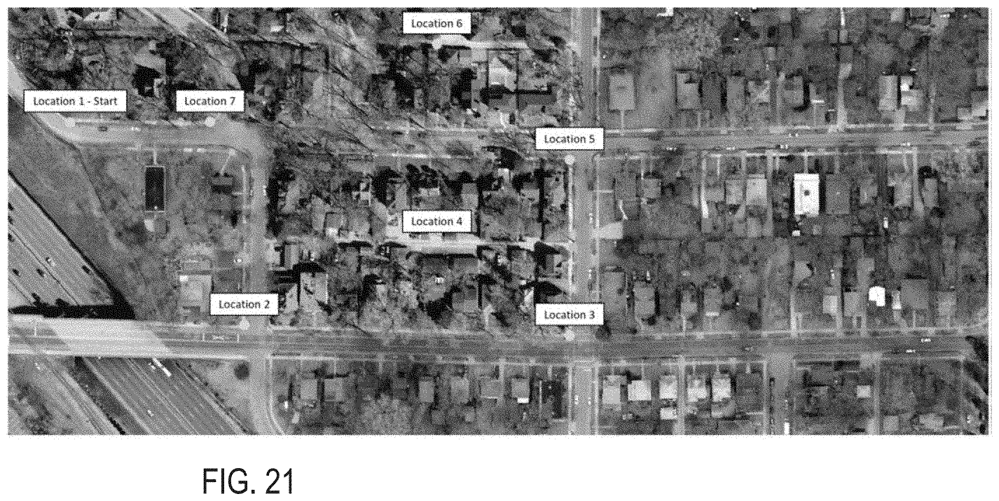

The automatically generated segmented map of the environment, described above, needs to be compared to a ‘ground truth’ to quantify the accuracy of the map. Since no map already exists, a ‘ground truth’ map was created by using an aerial orthorectified image of the neighborhood and manually edited to add the proper labels. The raw orthorectified image can be seen in FIG. 17 and the manually labeled image can be seen in FIG. 18. The segmented map automatically generated in this project was converted from a 3D point cloud down to a 2D image and then overlaid and compared to the orthorectified image to generate a measure of accuracy. The 2D point cloud image and the image overlay can be seen in FIG. 19 and FIG. 20, respectively. Since sidewalks are an important aspect of the segmentation, accuracy results for the sidewalks will be discussed below.

In FIG. 19 and FIG. 20, one can see that at intersections there are green point cloud data indicating a sidewalk where there is actually a road. The reason for this is that while crossing the intersection, identifying a road (curb, drop in elevation) may fail when the vehicle is actually on the road. As a result, the system is programmed to classify these points as a “sidewalk” even though that is not the case. However, this is not an issue because in most cases it is acceptable for the vehicle to consider identified portions of intersections and crosswalks as “sidewalks”. As a result, in the sidewalk classification results below, these ‘sidewalk’ points are not considered for pixel comparison. In some configurations, the vehicle may not be programmed to actively take into account traffic when crossing an intersection and will attempt to cross the street regardless of cars and pedestrians that may be on the road. In these instances, the user supervising can pause the vehicle when there is traffic on the road.

To evaluate the accuracy, the true positive (TP) and false positive (FP) for the sidewalk is calculated. This was done by a pixel comparison between the two images using MATLAB. The pixels that are classified as a sidewalk by the LIDAR are checked with the manually labeled image to see if it is a correct classification or a false classification. The results can be seen in Table 2 below. The sidewalk was 91.46% accurately classified and 8.54% falsely classified as sidewalk. As previously mentioned, the system classifies a portion of the road as ‘sidewalk’ while crossing an intersection and consequently much of the false positive classification results below can be attributed to this.

TABLE 2

| Classification | TP | FP |
|---|---|---|
| Sidewalk | 91.46% | 8.54% |

### Localization Results

To test the accuracy of the localization system, a ‘ground truth’ can be used. The high accuracy GNSS system described above was used to survey areas in the neighborhood where high accuracy results were available. This can only be done in GNSS areas with good reception, and since a majority of the area is covered in tree canopy or overshadowed by buildings, there were only seven consistent locations in the neighborhood that were identified that could be accurately surveyed. These locations are indicated on the map in FIG. 21.

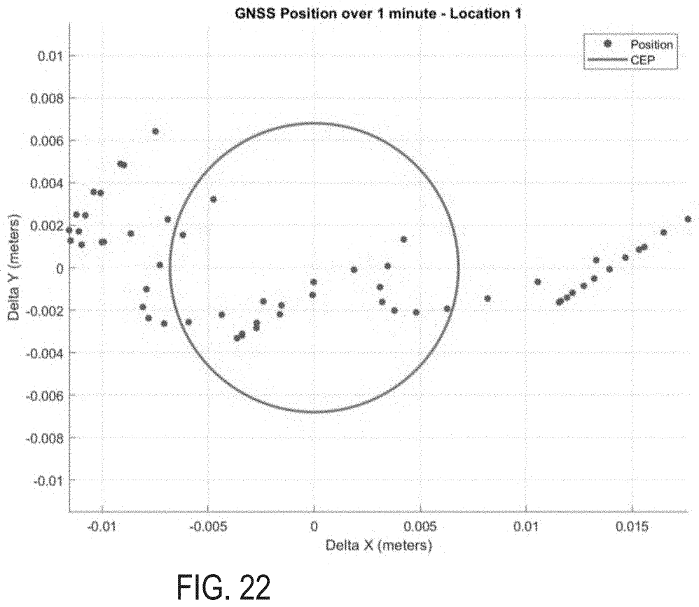

To validate the accuracy in the areas with good GNSS reception, the vehicle was driven to each location with known high quality GNSS reception (clearings, intersections) and parked. GNSS coordinates were recorded over a one minute span. One minute was experimentally found to be enough time to get an accurate estimation of the true latitude and longitude. The GNSS coordinates were then converted to Universal Transverse Mercator (UTM) coordinates, which is in meters, and averaged over that period of time to generate a ‘ground truth’ latitude and longitude. The accuracy of the GNSS position at these locations was found by calculating the circular error probable (CEP). The CEP is a measure of the median error radius of all the location points recorded and allows for the quantification of the quality of the GNSS signal at these locations. A scatter plot showing the results of the GNSS latitude and longitude readings over a one minute period and the CEP error circle for location 1 is shown in FIG. 22.

As the robot travels between two points and passes through these surveyed areas, the estimated position of the vehicle from the localization scheme EKF can be compared to the true value as it passes through the surveyed area. The localization results were recorded for two runs. The first run was conducted during the summertime under clear sky conditions and no snow on the ground while the second run was conducted during winter under cloudy conditions with fresh snow cover on the ground.

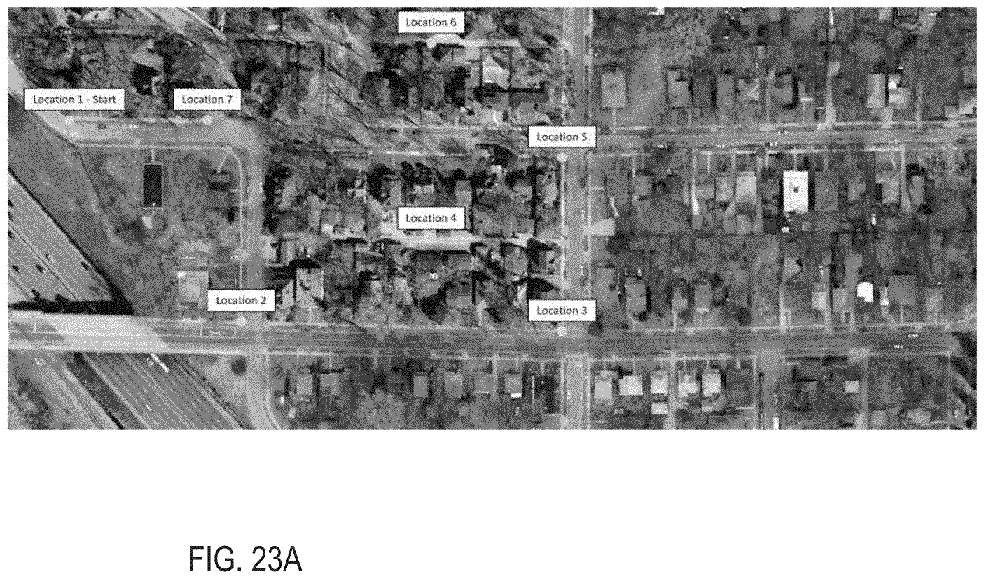

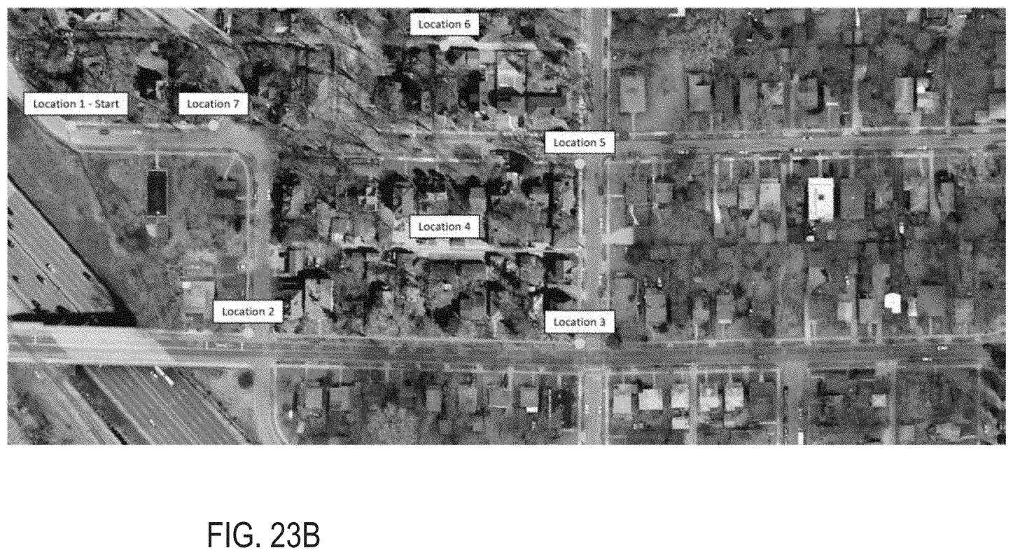

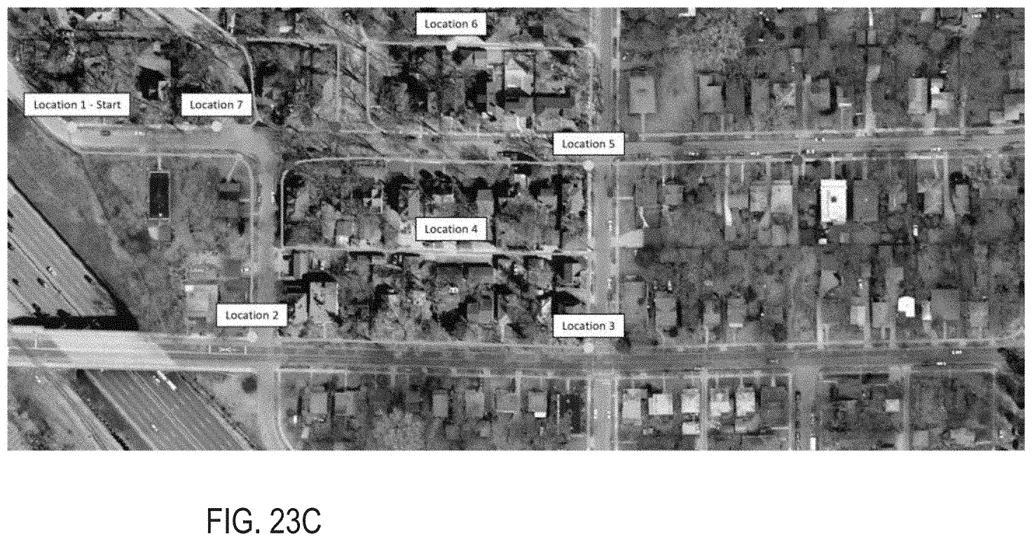

A table showing the CEP GNSS quality values for all seven locations as well as the total distance from the start (location 1) that the vehicle traveled as it reached the respective location and the recorded error for both the summer and winter runs can be seen in Table 3. The vehicle was given these seven waypoints as consecutive destinations to which to navigate. The vehicle was also given five other intermediate waypoints to travel through, shown as red circles in FIG. 23. These additional waypoints can be used to have the vehicle travel on most of the sidewalks in the neighborhood. The system automatically generated a path between the seven high accuracy GNSS locations and five waypoints using the path generator described above and autonomously traveled starting at location 1 through all subsequent locations until location 7 was reached. This explains why the path seems convoluted. The objective was to travel between all these locations and create a longer path within the neighborhood for testing and evaluation. Once a location is reached, the error is calculated by finding the distance between where the vehicle thinks it is in the world, via the localization scheme described above, and the true location that was surveyed. The vehicle then travels to the next subsequent location. For example, once the vehicle reaches location 2, the error is calculated between actual and expected coordinates, then the vehicle continues to location 3 (adding on to the previous path between location 1 to location 2). This is continued until location 7 is reached. The paths taken between several example location can be seen in FIG. 23.

TABLE 3

| | GNSS CEP | Distance | Summer | Winter |
|---|---|---|---|---|
| Location | Accuracy [m] | Traveled [m] | Error [m] | Error [m] |
| 1 | 0.0068 | 0 | 0.004 | 0.012 |
| 2 | 0.0045 | 186 | 0.051 | 0.056 |
| 3 | 0.0044 | 352 | 0.032 | 0.102 |
| 4 | 0.0063 | 470 | 0.059 | 0.062 |
| 5 | 0.0041 | 832 | 0.080 | 0.077 |
| 6 | 0.0036 | 1333 | 0.125 | 0.089 |
| 7 | 0.0049 | 1615 | 0.041 | 0.113 |

The average error of the localization system is 0.056 m in the summer and 0.073 m in the winter with snow on the ground. This metric was chosen to evaluate the localization system as opposed to the Success weighted by Path Length (SPL) measure proposed by Anderson et al. because in the example applications described in the present disclosure the shortest path between two points may not always the best path. In the above Table 3, in order to calculate the error, the true latitude and longitude of each respective point is converted to X Y coordinates in the vehicle frame. As the vehicle passes through the location, the estimated X Y position from the EKF is compared to the true X Y location, and the error is calculated as the difference. Additionally, the distance traveled is the total distance the vehicle has moved from the start of the path (location 1). The locations in Table 3 are all locations with good GNSS reception, and as a result, it is likely that the vehicle will correct its position estimate as it travels through these points. The error of the position estimate before and after the vehicle travels through the respective points, both in summer and winter, can be seen in Table 4 below.

TABLE 4

| | Summer - | Summer - | Winter - | Winter - |
|---|---|---|---|---|
| Location | Error Before | Error After | Error Before | Error After |
| 1 | — | — | — | — |
| 2 | 0.051 | 0.016 | 0.056 | 0.017 |
| 3 | 0.032 | 0.012 | 0.102 | 0.032 |
| 4 | 0.059 | 0.18 | 0.062 | 0.013 |
| 5 | 0.080 | 0.21 | 0.077 | 0.015 |
| 6 | 0.125 | 0.29 | 0.089 | 0.22 |
| 7 | 0.041 | 0.012 | 0.113 | 0.29 |

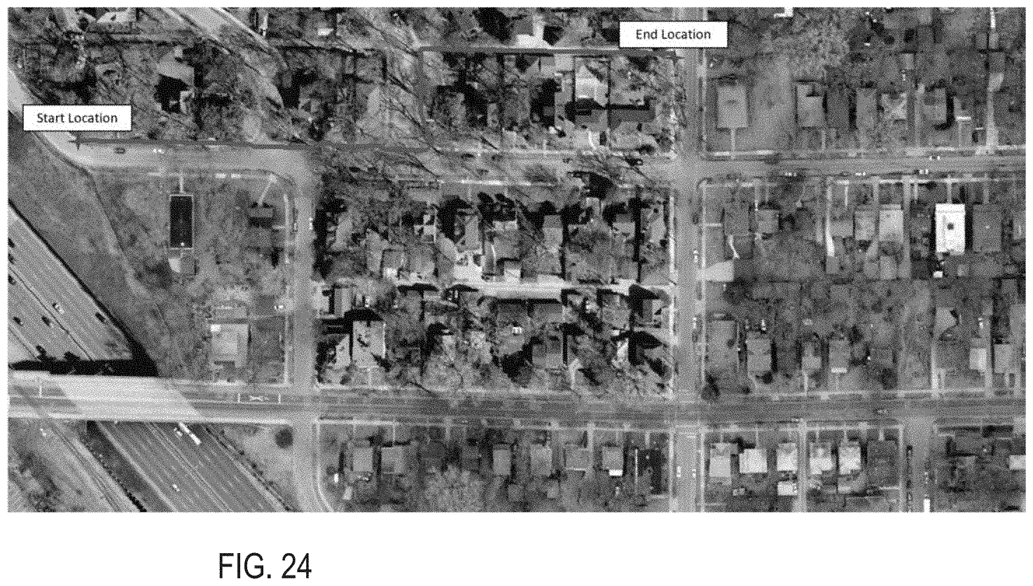

To demonstrate the system traveling a longer distance without feeding it waypoints or correction locations, such as in FIG. 23 above, the vehicle was given a destination point 500 meters away to navigate to in the winter. The locations of the start and destination locations as well as the path taken between the locations can be seen in FIG. 24. On the particular day of this experiment the end location of the path turned out to be in a high accuracy GNSS location, which allowed for the localization error accumulated while traveling the path to be estimated based off where the localization scheme believed the vehicle to be and where the GNSS receiver indicated that it was. This localization error was found to be 0.016 meters. For this particular path, the vehicle did travel through locations 6 and 7 (FIG. 21) so corrections based on the high accuracy GNSS were likely made in the localization scheme, however this path was not deliberate. The vehicle crossed two streets while traveling this path and each time the operator supervising the vehicle had to make sure the streets were safe to cross, as the vehicle was not monitoring for traffic.

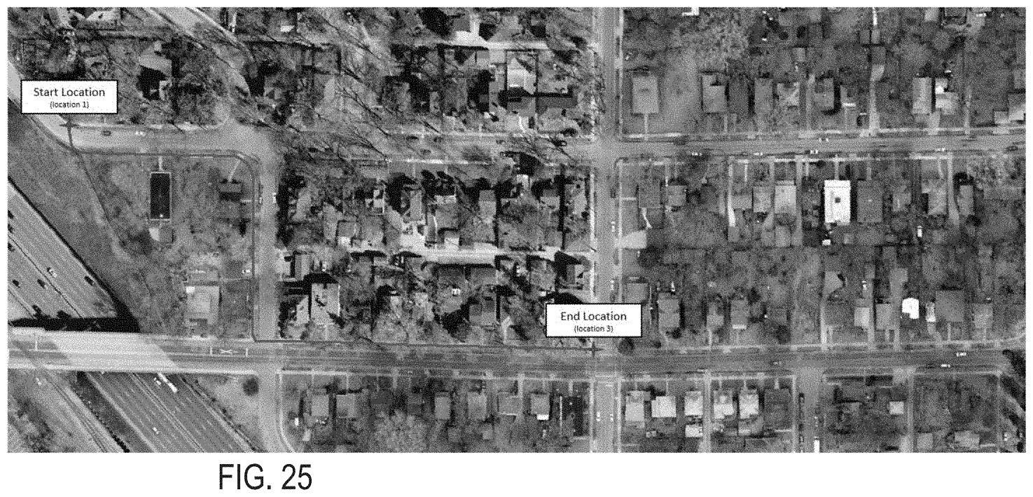

As a check to determine if the proposed localization scheme performs better than just by using the LIDAR odometry alone, the vehicle was driven from location 1 to location 3 (FIG. 21) without any GNSS data fed into the EKF (aside from using GNSS for initial localization) during the summer time. Since there is no GNSS information available to the EKF, there will be no GNSS corrections and the localization scheme will rely solely on the LIDAR odometry while traveling between the two points. The path taken by the vehicle can be seen in FIG. 25.

The error at the end of this 350 meter path was 0.153 meters. This is worse than the 0.032 meter error the vehicle incurred while traveling through location 3 during the summer time with GNSS actively being fed into the GNSS (Table 3). This shows that fusing together the high accuracy GNSS together with the LIDAR odometry does in fact provide better localization accuracy. The accuracy of the LIDAR odometry is a function of the number of distinctive features visible to the LIDAR in the nearby environment. This neighborhood provides many distinct features for the LIDAR to process, however, some parts of the neighborhood may provide more distinctive features than others. As a result, it is contemplated that the accuracy of the LIDAR odometry may vary slightly because of this.

In the examples described in the present disclosure, it was assumed that the vehicle starts in a high accuracy GNSS location. This constraint can also be resolved by creating high quality LIDAR based landmarks which allow the robot to localize accurately instead of relying on only GNSS. Also, it is assumed that the sidewalks are of reasonably good quality and are not covered in grass or leaves when collecting the initial data.

Some scenarios where the proposed system may encounter problems are during heavy snowfall or rainfall. The system relies on LIDAR when no GNSS is available and LIDAR data quality deteriorates under these weather conditions. The LIDAR odometry may also drift significantly due to lack of features in the area (as would be the case next to an open field) or finding too many similar features between the high accuracy GNSS locations. This latter situation of too many “similar” features was identified when operating next to a building with many identical window frames adjacent to the robot's path. As a result, the drift may cause the robot to veer off the sidewalk before it can correct for the error with GNSS. This scenario is highly unlikely in a residential neighborhood.

In some configurations, the system does not actively monitor traffic at intersections and as a result is not aware of oncoming vehicles when crossing the intersection. In alternative configurations, features such as the functionality of monitoring traffic at intersections, the LIDAR on the vehicle can be programmed to detect vehicles, bikes, and other pedestrians on the roads can be added. An algorithm could be designed to identify the flow of the traffic in the street and determine if the intersection is clear of any oncoming vehicles. This information could be used to autonomously pause the robot while crossing intersections to avoid the risk of collisions.

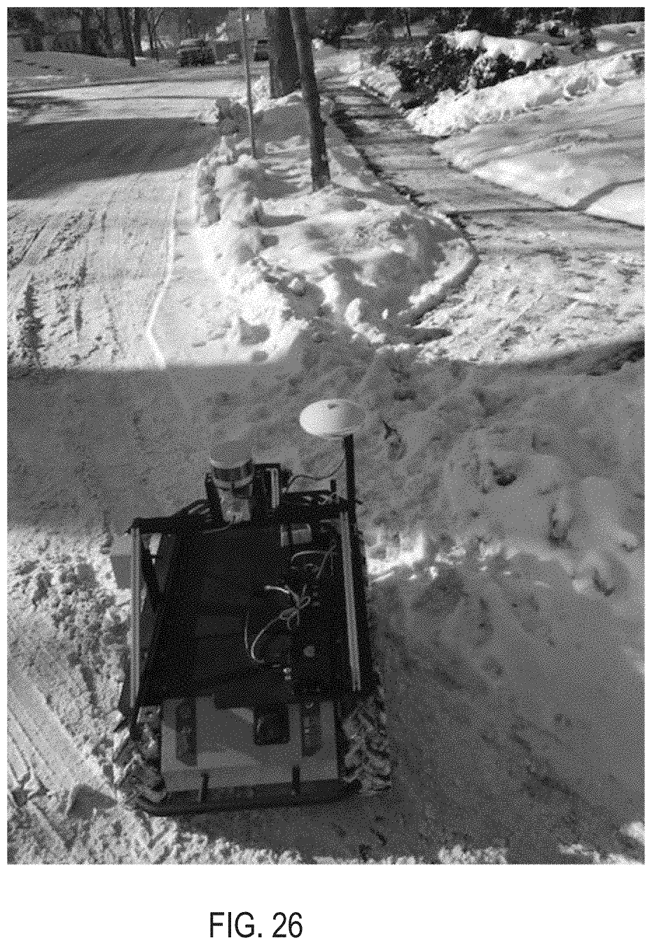

Generating localization results in a snowy neighborhood proved challenging. The issues encountered in the winter may have nothing to do with the sensors or the vehicle, but rather can involve piles of snow blocking sidewalks and leaving no viable path for the vehicle to travel. An example of a pile of snow blocking a curb cut that would normally allow the vehicle to get onto a sidewalk is shown in FIG. 26.

The quality of snow removal on sidewalks and streets varies highly among neighborhoods and households. This is due to the fact that many households are responsible for the removal of snow on the sidewalks in front of their house. Some people do a good job removing the snow while others may not do it at all. This, in addition to snow plows creating snow piles that block many curb cuts, provides for a challenging environment for sidewalk path planning and navigation in snowy environments. Clearly the local jurisdiction or neighbors need to ensure that the curb cuts are also cleared of snow and not just the sidewalks.

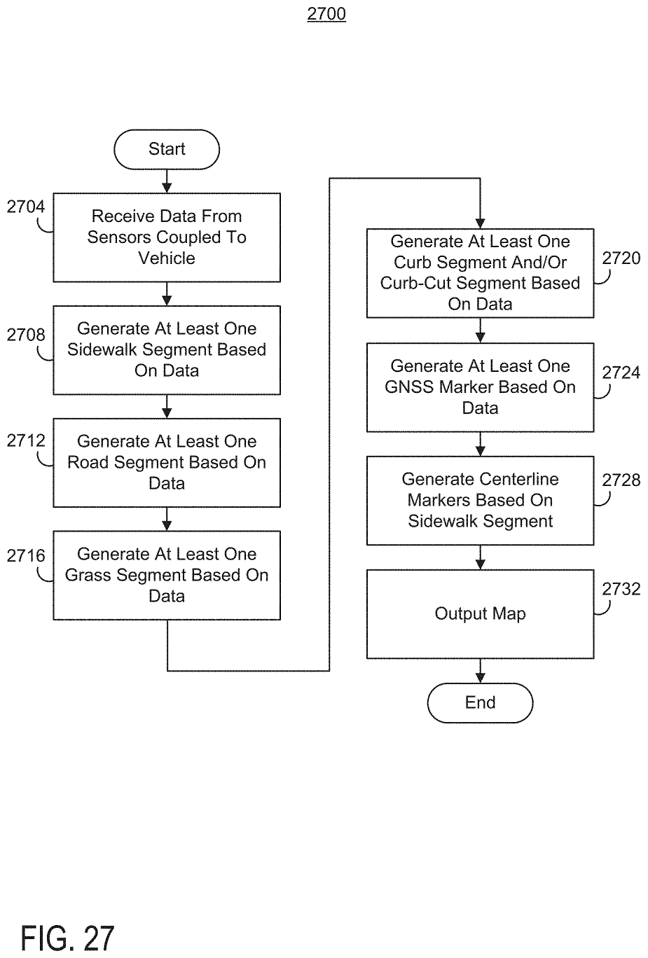

Referring now to FIG. 27, a process 2700 for generating a map of a paved pathway is shown. In some embodiments, the vehicle can be a UGV. In some embodiments, the vehicle can be a skid-steer such as the Husky in FIG. 2. In some embodiments, the process 2700 can be implemented as computer readable instructions on at least one memory and executed by at least one processor coupled to the at least one memory.

At 2704, the process 2700 can receive data from sensors coupled to the vehicle. In some embodiments, the sensors can generate the data as the vehicle is piloted along a paved pathway such as a sidewalk and/or alley. In some embodiments, the vehicle can be piloted by a person pushing the vehicle and/or a person remotely controlling the vehicle to proceed along the paved pathway. In some embodiments, the vehicle can autonomously navigate along the paved pathway. The data can be generated when there is not snow on the paved pathway. In some embodiments, the sensors coupled to the vehicles can include a GNSS sensor and a LIDAR sensor. In some embodiments, the LIDAR sensor can be a Trimble GNSS antenna and RTK receiver, and the LIDAR sensor can be a Velodyne VLP-16 LIDAR. In some embodiments, the sensors can include an IMU sensor such as a Phidgets IMU. The GNSS sensor can be a high-accuracy GNSS sensor (e.g., accurate to a centimeter or less). The data received from the sensors can include LIDAR scans (e.g., a three-dimensional point cloud) from the LIDAR sensor and a location value (e.g., coordinate values) and/or reception value (e.g., strength of signal value) from the GNSS sensor. In some embodiments, the data received from the sensors can include a yaw value from the IMU sensor. The process 2700 can then proceed to 2704.

At 2708, the process 2700 can generate at least one sidewalk segment based on the data. In some embodiments, the process 2700 can determine that a first portion of a LIDAR point cloud included in the data is located above a second portion of the LIDAR point cloud. The process 2700 can then determine that the first portion of the LIDAR point cloud is included in a sidewalk segment. In some embodiments, the process 2700 can determine that a third portion of the LIDAR point cloud has a roughness below a predetermined threshold, and is included in a sidewalk segment. Sidewalks are commonly surrounded by grass, curbs, walls, vegetation, etc. that are less smooth than the sidewalk. The process 2700 can determine that portions of the LIDAR cloud that are not below the predetermined threshold for roughness are not sidewalk segments. The third portion may be the first portion. In some embodiments, the process 2700 can determine that a fourth portion of the LIDAR point cloud does not have a sufficient curvature to be considered a roadway. Sidewalks are commonly flat, while roadways commonly are curved to allow for drainage. The fourth portion may be the third portion. In some embodiments, the process 2700 can generate alley segments using at least a portion of the same criteria as the sidewalk segment. For example, the process 2700 can determine a fifth portion of the LIDAR point cloud has a roughness below the predetermined threshold and that the fifth portion of the LIDAR point cloud does not have a sufficient curvature to be considered a roadway. The process 2700 can perform the above determinations for any number of LIDAR point clouds included in the data. The process 2700 can then proceed to 2712.

At 2712, the process 2700 can generate at least one roadway segment based on the data. In some embodiments, for a LIDAR point cloud, the process 2700 can determine a target portion of the LIDAR point cloud that includes points below the base of the vehicle. For example, the process 2700 can determined the location of the base of the vehicle based on the mounting height of the LIDAR sensor, which can be predetermined. The process 2700 can include all points in the LIDAR point cloud below the base of the vehicle in the target portion. The process 2700 can determine which subportion(s), if any, of the target portion have sufficient curvature to be included in a roadway segment. The process 2700 can include any subportions of the target portion that exhibit light curvature in the map as roadway segments. The process 2700 can perform the above determinations for any number of LIDAR point clouds included in the data. The process 2700 can then proceed to 2716.

At 2716, the process 2700 can generate at least one grass segment based on the data. In some embodiments, the process 2700 can determine one or more portions of a LIDAR point cloud are noisier than a predetermined threshold. In some embodiments, the process 2700 can determine, for a set of points included in the LIDAR point cloud and corresponding to a single channel of the LIDAR sensor, which points deviate substantially from a previous number of points. In some embodiments, the process 2700 can determine which points have heights that differ substantially (e.g., 1.85 standard deviations) from a previous number of points (e.g., twenty-five points). The number of standard deviations and/or the previous number of points can be selected based on application. The process 2700 can classify points that deviate by more than the predetermined number of standard deviations as part of a grass segment. The process 2700 can perform the above determinations for any number of LIDAR point clouds included in the data. The process 2700 can then proceed to 2720.

At 2720, the process 2700 can generate at least one curb segment and/or curb-cut segment based on the data. In some embodiments, the process 2700 can determine if a portion of a LIDAR point cloud associated with the ground (e.g., points below the LIDAR sensor) includes points that maintain a constant height and then jump to a higher or lower value. In some embodiments, the process 2700 the process can compare heights of points in the LIDAR point cloud across the width of the sidewalk, and determine the height remains constant for a number of points, rapidly changes to a second height, and then remains at the second height for a number of points, indicating a curb. The process 2700 can then include all points between and/or including the edge of the street to the edge of the sidewalk in a curb segment. The process 2700 can generate one or more curb-cut segments by determining portions of the point cloud where the curb segment gradually slopes down to the street, indicating a curb-cut. At 2720, the process 2700 can also generate one or more obstacle segments by determining one or more portions of the LIDAR point scan that do not meet the criteria for a sidewalk segment, an alley segment, a road segment, a grass segment, a curb segment, and/or a curb-cut segment. The process 2700 can perform the above determinations for any number of LIDAR point clouds included in the data. The process 2700 can then proceed to 2724.

At 2724, the process 2700 can generate at least one GNSS marker based on the data. Due to environmental factors such as tree cover, the accuracy of the GNSS sensor may vary while traveling along the paved pathway. The process 2700 can determine locations along the paved pathway at which the GNSS location is of high accuracy by ensuring that its covariance matrix stays below a predetermined threshold (e.g., that the first element of the diagonal stays below 0.00055 in metric units) and will generate a GNSS marker at these locations. When traveling along the paved pathway in the future, the location error of the vehicle can be “zeroed” (e.g., to reduce drift) at these GNSS markers. In some embodiments, the process 2700 can generate the GNSS markers based on fix type (e.g., a RTK fixed integer solution technique). Some GNSS receivers indicate the accuracy of the location based on fix type, which is determined by the receiver based on the number of satellites visible, the dilution of precision of, the satellites, the type of GNSS receiver, and the GNSS technology being used. In some embodiments, fix type may not be available, and the overall quality of the GNSS signal can be determined based on the covariance matrix. The process 2700 can then proceed to 2728.

At 2728, the process 2700 can generate at least one centerline marker based on the data. For each LIDAR point cloud with a sidewalk segment and/or alley segment, the process 2700 can determine a portion of the sidewalk segment or other alley segment corresponding to the first (or the lowest in elevation) channel of the LIDAR sensor (e.g., points generated by the first channel that are included in the sidewalk segment or other alley segment), and determine the center of the portion. The process 2700 can average the centers from a number of LIDAR point clouds and generate a centerline marker based on the average location of the centers. In some embodiments, the process 2700 can average the centers every meter to generate a centerline marker. The process 2700 can convert the location of the centerline markers to GNSS coordinates based on the GNSS data. The process 2700 can then proceed to 2732.

At 2732, the process 2700 can output the map to a memory. In some embodiments, the process 2700 can save the map to a memory in the vehicle. The map can include at least a portion of the LIDAR point clouds included in the LIDAR data, the segments generated at 2708-2720, the GNSS markers generated at 2724, and/or the centerline markers generated at 2728. The process 2700 can then end.

It is understood that the process 2700 may not generate certain segments and/or markers at 2712-2724. In other words, the process 2700 may not generate at least one of a roadway segment, a grass segment, a curb segment, a curb-cut segment, and/or a GNSS marker. For example, the data received at 2704 may not be associated with an area, such as certain types of alleyways, including features such as roadways, grass, curb-cuts, and/or curbs. As another example, certain commercial business districts may not include grass, and the process 2700 may not generate any grass segments based on data associated with the commercial business districts. As yet another example, some areas, such as sidewalks with heavy tree coverage, may receive GNSS signals without sufficient quality for the process 2700 to generate any GNSS markers.

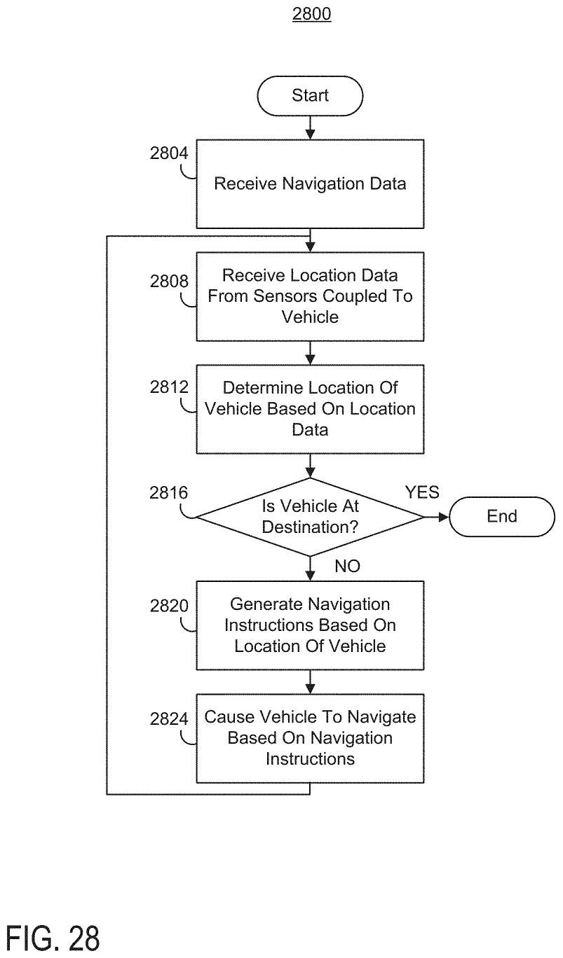

Referring now to FIG. 28, a process 2800 for navigating a paved pathway is shown. In some embodiments, the vehicle can be a UGV. In some embodiments, the vehicle can be a skid-steer such as the Husky in FIG. 2. In some embodiments, the process 2800 can be implemented as computer readable instructions on at least one memory and executed by at least one processor coupled to the at least one memory.

At 2804, the process 2800 can receive navigation data. The navigation data can include a map generated using the process 2700 in FIG. 27. The navigation data can also include a start point and a destination point corresponding to locations in the map. In some embodiments, the start point and the destination point can be generated by generating a path in a road-based mapping application (e.g., Google Maps), and shifting road centerlines in the path to centerline markers in one or more sidewalks and/or alleys in the map. The map can include a vehicle path that includes the centerline markers. The vehicle path may only include portions of sidewalks, alleys, curb-cuts, and portions of a street between curb-cuts (e.g., crosswalks). The process 2800 can then proceed to 2808.

At 2808, the process 2800 can receive location data from sensors located in the vehicle. The location data can be generated in the presence of snow on the paved pathway. The location data can be generated without the presence of snow on the paved pathway. In some embodiments, the sensors coupled to the vehicles can include a GNSS sensor and a LIDAR sensor. In some embodiments, the LIDAR sensor can be a Trimble GNSS antenna and RTK receiver, and the LIDAR sensor can be a Velodyne VLP-16 LIDAR. In some embodiments, the sensors can include an IMU sensor such as a Phidgets IMU. The GNSS sensor can be a high-accuracy GNSS sensor (e.g., accurate to a centimeter or less). The location data received from the sensors can include LIDAR scans (e.g., a three-dimensional point cloud) from the LIDAR sensor and a location value (e.g., coordinate values) and/or reception value (e.g., strength of signal value) from the GNSS sensor. In some embodiments, the location data received from the sensors can include a yaw value from the IMU sensor. The process 2800 can then proceed to 2812.

At 2812, the process 2800 can determine the location of the vehicle based on the location data. In some embodiments, the process 2800 can determine the location of the vehicle based on the GNSS data and/or the LIDAR data using an Extended Kalman Filter (EKF). In some embodiments, the process 2800 can calculate Δx, Δy, and Δyaw values based on the LIDAR data using LeGO-LOAM. In some embodiments, the process 2800 can provide the Δx, Δy, and Δyaw values to an EKF along with x and y values included in the GNSS data if the GNSS data is not accurate enough. In some embodiments, the process 2800 can determine a covariance matrix based on the quality of GNSS reception for the x and y values, and filter out GNSS coordinates if the covariance is above a threshold value. In other words, the process 2800 may only provide LeGO-LOAM data to the EKF if the GNSS data is not accurate enough. To initialize the EKF, the process 2800 may provide a yaw value received from the IMU sensor along with the LIDAR and/or GNSS data. The EKF can generate a global vehicle location value including an x value, a y value, and a yaw value. The global vehicle location value can be used as the location of the vehicle. The process 2800 can then proceed to 2820.

At 2816, the process 2800 can determine if the vehicle is at the destination. In some embodiments, the process 2800 can determine if the location value is within a predetermined margin of the destination (e.g., within five centimeters of the destination), indicating that the vehicle is at the destination. If the vehicle is not at the destination (e.g. “NO” at 2816), the process 2800 can proceed to 2820. If the vehicle is at the destination (e.g., “YES” at 2816), the process 2800 can end.

At 2820, the process 2800 can generate navigation instructions based on the location of the vehicle. In some embodiments, the process 2800 can determine the next centerline marker that the vehicle needs to travel to in order to proceed to the destination, and generate the navigation instructions to cause the vehicle to move from the current location to and/or in the direction of the next centerline marker. In some embodiments, the navigation instructions can include velocity commands. The process 2800 can then proceed to 2824.

At 2824, the process 2800 can cause the vehicle to navigate based on the navigation instructions. In some embodiments, the process 2800 can provide the navigation instructions to a drive system of the vehicle. The process 2800 can then proceed to 2808.

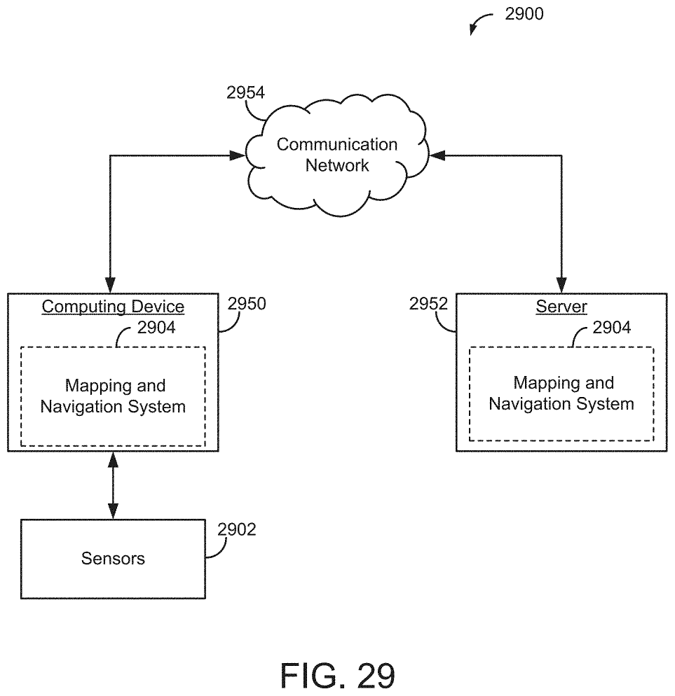

Referring now to FIG. 29, an example of a system 2900 for generating maps and navigating vehicles in accordance with some embodiments of the systems and methods described in the present disclosure is shown. As shown in FIG. 29, a computing device 2950 can receive one or more types of data (e.g., LIDAR data, GNSS data, IMU data) from a number of sensors 2902, which can be sensors coupled to a vehicle such as a skid-steer, as one non-limiting example. In some embodiments, computing device 2950 can execute at least a portion of a mapping and navigation system 2904 to map and navigate the vehicle based on data received from the sensors 2902. In some embodiments, the mapping and navigation system 2904 can include the process 2700 in FIG. 27 and/or the process 2800 in FIG. 28.

Additionally or alternatively, in some embodiments, the computing device 2950 can communicate information about data received from the sensors 2902 to a server 2952 over a communication network 2954, which can execute at least a portion of the mapping and navigation system 2904 to analyze from data received from the sensors 2902. In such embodiments, the server 2952 can return information to the computing device 2950 (and/or any other suitable computing device) indicative of an output of the mapping and navigation system 2904 to analyze from data received from sensors 2902.

In some embodiments, computing device 2950 and/or server 2952 can be any suitable computing device or combination of devices, such as a desktop computer, a laptop computer, a tablet computer, a server computer, a virtual machine being executed by a physical computing device, and so on. In some embodiments, sensors 2902 can include an IMU sensor, a GNSS sensor, and a LIDAR sensor. In some embodiments, the sensors 2902 can be coupled to the vehicle.

In some embodiments, communication network 2954 can be any suitable communication network or combination of communication networks. For example, communication network 2954 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), a wired network, and so on. In some embodiments, communication network 2954 can be a local area network, a wide area network, a public network (e.g., the Internet), a private or semi-private network (e.g., a corporate or university intranet), any other suitable type of network, or any suitable combination of networks. Communications links shown in FIG. 29 can each be any suitable communications link or combination of communications links, such as wired links, fiber optic links, Wi-Fi links, Bluetooth links, cellular links, and so on.

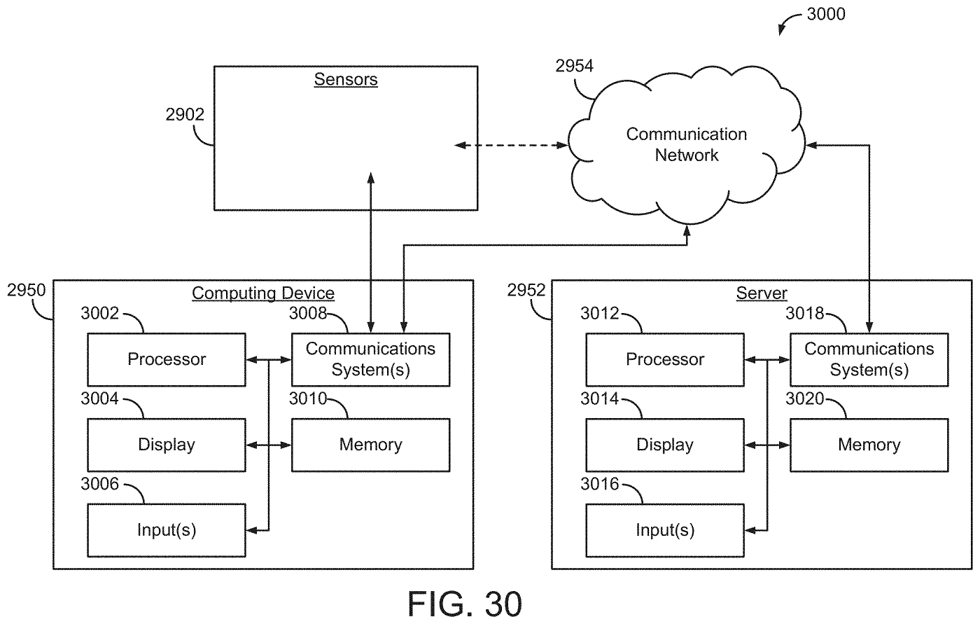

Referring now to FIG. 30, an example of hardware 3000 that can be used to implement sensors 2902, computing device 2950, and server 2952 in accordance with some embodiments of the systems and methods described in the present disclosure is shown. As shown in FIG. 30, in some embodiments, computing device 2950 can include a processor 3002, a display 3004, one or more inputs 3006, one or more communication systems 3008, and/or memory 3010. In some embodiments, processor 3002 can be any suitable hardware processor or combination of processors, such as a central processing unit (“CPU”), a graphics processing unit (“GPU”), and so on. In some embodiments, display 3004 can include any suitable display devices, such as a computer monitor, a touchscreen, a television, and so on. In some embodiments, inputs 3006 can include any suitable input devices and/or sensors that can be used to receive user input, such as a keyboard, a mouse, a touchscreen, a microphone, and so on.

In some embodiments, communications systems 3008 can include any suitable hardware, firmware, and/or software for communicating information over communication network 2954 and/or any other suitable communication networks. For example, communications systems 3008 can include one or more transceivers, one or more communication chips and/or chip sets, and so on. In a more particular example, communications systems 3008 can include hardware, firmware and/or software that can be used to establish a Wi-Fi connection, a Bluetooth connection, a cellular connection, an Ethernet connection, and so on.

In some embodiments, memory 3010 can include any suitable storage device or devices that can be used to store instructions, values, data, or the like, that can be used, for example, by processor 3002 to present content using display 3004, to communicate with server 2952 via communications system(s) 3008, and so on. Memory 3010 can include any suitable volatile memory, non-volatile memory, storage, or any suitable combination thereof. For example, memory 3010 can include RAM, ROM, EEPROM, one or more flash drives, one or more hard disks, one or more solid state drives, one or more optical drives, and so on. In some embodiments, memory 3010 can have encoded thereon, or otherwise stored therein, a computer program for controlling operation of computing device 2950. In such embodiments, processor 3002 can execute at least a portion of the computer program to present content (e.g., images, user interfaces, graphics, tables), receive content from server 2952, transmit information to server 2952, and so on.

In some embodiments, server 2952 can include a processor 3012, a display 3014, one or more inputs 3016, one or more communications systems 3018, and/or memory 3020. In some embodiments, processor 3012 can be any suitable hardware processor or combination of processors, such as a CPU, a GPU, and so on. In some embodiments, display 3014 can include any suitable display devices, such as a computer monitor, a touchscreen, a television, and so on. In some embodiments, inputs 3016 can include any suitable input devices and/or sensors that can be used to receive user input, such as a keyboard, a mouse, a touchscreen, a microphone, and so on.

In some embodiments, communications systems 3018 can include any suitable hardware, firmware, and/or software for communicating information over communication network 2954 and/or any other suitable communication networks. For example, communications systems 3018 can include one or more transceivers, one or more communication chips and/or chip sets, and so on. In a more particular example, communications systems 3018 can include hardware, firmware and/or software that can be used to establish a Wi-Fi connection, a Bluetooth connection, a cellular connection, an Ethernet connection, and so on.

In some embodiments, memory 3020 can include any suitable storage device or devices that can be used to store instructions, values, data, or the like, that can be used, for example, by processor 3012 to present content using display 3014, to communicate with one or more computing devices 2950, and so on. Memory 3020 can include any suitable volatile memory, non-volatile memory, storage, or any suitable combination thereof. For example, memory 3020 can include RAM, ROM, EEPROM, one or more flash drives, one or more hard disks, one or more solid state drives, one or more optical drives, and so on. In some embodiments, memory 3020 can have encoded thereon a server program for controlling operation of server 2952. In such embodiments, processor 3012 can execute at least a portion of the server program to transmit information and/or content (e.g., data, images, a user interface) to one or more computing devices 2950, receive information and/or content from one or more computing devices 2950, receive instructions from one or more devices (e.g., a personal computer, a laptop computer, a tablet computer, a smartphone), and so on.

In conclusion, the present disclosure provides a system that can automatically localize by fusing high accuracy GNSS and LIDAR Odometry and an algorithm that can automatically detect and label relevant ground features such as sidewalks, roads, grass, curb cuts when there is little to no snow on the ground. By using this information, the robot can travel from pt. A to pt. B using only sidewalks and curb cuts. Google Maps API can be utilized to provide the advantage of being able to use street names. The API automatically generates a path along road centerlines between the two points, which then can be modified for sidewalks. The system can be used to travel under most weather conditions even when the sidewalks are covered in snow (as long as the snow does not block travel). Vision is intentionally not being used in this research, thus the system is not typically affected by snow cover.

An accuracy rating of 91.46% true positives for mapping sidewalks and an average error for the localization scheme of 0.056 meters in the summer and 0.073 meters in the winter for paths as long as 1.5 Km was achieved. The proposed localization scheme provided better accuracy than relying solely on LIDAR odometry by achieving 0.032 meters of error compared to 0.153 meters moving between locations 1 and 3. Although there is less tree canopy above the vehicle in the winter, likely resulting in better GNSS reception throughout the path, the average error was slightly worse than in the summer. This may be attributed to the snow covering some features that LIDAR odometry uses for localization. Better sidewalk classification can be achieved by further research into understanding how to filter out vegetation in LIDAR scans, however, the accuracy achieved in our project has proven to be sufficient for sidewalk navigation of UGVs in urban environments with or without snow cover. The level of localization accuracy achieved using the systems and methods described in the present disclosure allow for navigation on sidewalks, especially in the case of autonomous wheelchair navigation. If the accuracy were any worse, the vehicle would likely begin traveling on grass or vegetation next to the sidewalk and miss the curb cuts. For accurate navigation of wheelchairs on sidewalks, RTK GNSS is currently used because uncorrected GNSS may not provide the accuracy desired to stay on the sidewalk and reach its destination address. However, with new GNSS satellites being launched every year, high accuracy GNSS will likely be available without the need for RTK within the next few years.

Additionally, LIDAR landmarks for localization estimation can be used in the case that the LIDAR odometry drifts in-between high accuracy GNSS locations. LIDAR landmarks can also remove the limitation of needing high accuracy GNSS for initial position estimate as the landmarks could provide this information instead.

The automatically generated segmented map can also be used for in-depth sidewalk assessment of parameters such as pavement quality, grade and width. This can also be updated over time as new data is collected. Introducing a high accuracy IMU into the localization scheme and actively feeding its data into the EKF (as opposed to just using it for initial heading) may improve the localization accuracy and as such is desired. Thus, in some embodiments, only LIDAR and GNSS may be needed to navigate sidewalks. In some embodiments, the systems and methods described herein can be utilized with a wheelchair (e.g., a motorized wheelchair) in order to provide automatic sidewalk navigation for a wheelchair user.

In some embodiments, the autonomous navigation system can travel on a side of a road where there are no sidewalks would facilitate wheelchair travel in the suburbs where there are fewer sidewalks present.

In some embodiments, the systems and methods described herein can be used for autonomous removal of snow from sidewalks. Most urban centers expect that homeowners remove snow from the sidewalks in front of their properties. Many do not comply. The result is that persons with disabilities are often stuck at home and cannot make their way to nearby stores or to public transit. Furthermore, cities located in northern climates often do not have a maintenance budget sufficient to clear snow from both the roads and the sidewalks. Snowplowing of the sidewalks by small autonomous vehicles may be the answer.

The present disclosure has described one or more preferred embodiments, and it should be appreciated that many equivalents, alternatives, variations, and modifications, aside from those expressly stated, are possible and within the scope of the invention.

1. A method for determining a location of an unmanned ground vehicle (UGV), the method comprising:
receiving LIDAR data with a computer system, wherein the LIDAR data are received from at least one LIDAR sensor mounted to the UGV;
receiving Global Navigation Satellite System (GNSS) data with the computer system, wherein the GNSS data are received from at least one GNSS sensor mounted to the UGV; and
computing location data with the computer system, wherein the location data are computed by fusing the LIDAR data and the GNSS data to determine a location of the UGV.

2. The method of claim 1, wherein the LIDAR data and the GNSS data are fused using an extended Kalman filter.

3. The method of claim 1, wherein the location data are computed without data that indicate position of one or more wheels of the UGV.

4. The method of claim 1, wherein the location data is computed in presence of slippage between one or more wheels of the UGV and a surface in contact with one or more wheels of the UGV.

5. The method of claim 1, wherein the location data are computed without rotary encoder data that indicate angular position or motion of one or more wheels of the UGV.

6. The method of claim 1, wherein the computer system is mounted to the UGV and the location data are computed using the computer system.

7. The method of claim 1, wherein the LIDAR data and the GNSS data are received while the UGV is moving along a pathway, and wherein the location data indicate a location of the UGV along the pathway.

8. A method for mapping a pathway, the method comprising:
receiving LIDAR data with a computer system, wherein the LIDAR data are received from at least one LIDAR sensor mounted to a vehicle as the vehicle moves along the pathway;
receiving Global Navigation Satellite System (GNSS) data with a computer system, wherein the GNSS data are received from at least one GNSS sensor mounted to the vehicle as the vehicle moves along the pathway; and
generating a pathway map based on the LIDAR data and the GNSS data using the computer system, wherein the pathway map comprises one or more segments each associated with one or more features of the pathway.

9. The method of claim 8, wherein the pathway comprises a paved pathway.

10. The method of claim 9, wherein the paved pathway is a sidewalk and the one or more segments include a sidewalk segment corresponding to sidewalk features and a curb cut segment corresponding to curb cut features.

11. The method of claim 10, wherein the sidewalk segment is generated by determining that a portion of a LIDAR point cloud included in the LIDAR data is located above another portion of the LIDAR point cloud.

12. The method of claim 11, wherein the sidewalk segment is further generated by determining that a portion of the LIDAR point cloud does not have a sufficient curvature to be considered a roadway.

13. The method of claim 10, wherein the pathway map further comprises a grass segment generated by determining that a portion of the LIDAR data has a roughness above a predetermined threshold.

14. The method of claim 13 further comprising:
generating an obstacle segment included in the pathway map by determining that the obstacle segment does not meet requirements of the sidewalk segment, the curb cut segment, and the grass segment.

15. The method of claim 9, wherein the paved pathway is an alley.

16. The method of claim 8 further comprising:
piloting the vehicle along the pathway without any snow covering the pathway based on input from a human operator.

17. The method of claim 8 further comprising:
generating a plurality of centerline markers along the pathway, the plurality of centerline markers being included in the pathway map.

18. The method of claim 8, wherein the GNSS data include at least one gap corresponding to locations along the pathway when the vehicle was unable to receive GNSS data.

19. The method of claim 8 further comprising:
providing the LIDAR data and the GNSS data to an extended Kalman filter in order to fuse the LIDAR data and the GNSS data, generating output as location data indicating a location of the vehicle along the pathway.

20. The method of claim 8 further comprising:
providing the pathway map to at least one differential drive vehicle.

21. The method of claim 8 further comprising:
generating at least one high accuracy GNSS marker based on the GNSS data, the at least one high accuracy GNSS marker being included in the pathway map.

22. A method for navigating a sidewalk at least partially covered with snow, the method comprising:
receiving LIDAR data from at least one LIDAR sensor mounted to a vehicle;
determining a command to send to a control system of the vehicle based on the LIDAR data and a map comprising a sidewalk segment, a curb cut segment, and a grass segment, the map being previously generated based on LIDAR data of the sidewalk without snow cover; and
outputting the command to the control system of the vehicle to advance the vehicle down the sidewalk.

23. The method of claim 22 further comprising:
navigating the vehicle to a predetermined Global Navigation Satellite System (GNSS) waypoint;
resetting a dead-reckoning location of the vehicle based on the waypoint; and
continuing to navigate the vehicle along the sidewalk using only LIDAR data.

24. The method of claim 22, wherein the map further comprises a plurality of centerline markers along the sidewalk.

25. The method of claim 22, wherein the vehicle cannot receive Global Navigation Satellite System (GNSS) data along at least a portion of the sidewalk.

26. The method of claim 22, wherein the sidewalk segment is generated by determining that a portion of a LIDAR point cloud is located above another portion of a LIDAR point cloud.

27. The method of claim 26, wherein the sidewalk segment is further generated by determining that a portion of a LIDAR point cloud does not have a sufficient curvature to be considered a roadway.

28. The method of claim 22, wherein the grass segment is generated by determining that a portion of a LIDAR point has roughness above a predetermined threshold.

29. The method of claim 22, wherein the map comprises an obstacle segment generated by determining that the obstacle segment does not meet requirements of the sidewalk segment, a curb cut segment, and a grass segment.

30. The method of claim 22 further comprising:
identifying a predetermined LIDAR landmark in the map;
determining a second command to send to a control system of the vehicle based on the predetermined LIDAR landmark and the map; and
outputting the second command to the control system of the vehicle to advance the vehicle down the sidewalk.

31. The method of claim 30, wherein the predetermined LIDAR landmark is a curb cut.

32. The method of claim 22, wherein the map is previously generated by manually piloting the vehicle along the sidewalk without any snow covering the sidewalk.

33. A system for navigating a sidewalk at least partially covered with snow, the system comprising:
a vehicle comprising a control system;
a LIDAR sensor coupled to the vehicle; and
a controller coupled to the vehicle and the LIDAR sensor and comprising a memory and a processor, the controller configured to execute instructions stored in the memory to:
receive LIDAR data from at the LIDAR sensor;
determine a command to send to the control system based on the LIDAR data and a map comprising a sidewalk segment, a curb cut segment, and a grass segment, the map being previously generated based on LIDAR data of the sidewalk without snow cover; and
output the command to the control system to advance the vehicle down the sidewalk.

34. The system of claim 33, wherein the controller is further configured to:
navigate the vehicle to a predetermined Global Navigation Satellite System (GNSS) waypoint;
receive GNSS data from a GNSS sensor mounted to the vehicle and coupled to the controller;
reset a dead-reckoning location of the vehicle based on the waypoint; and
continue to navigate the vehicle along the sidewalk using only LIDAR data.

35. The system of claim 33, wherein the map further comprises a plurality of centerline markers along the sidewalk.

36. The system of claim 33, wherein the controller cannot receive Global Navigation Satellite System (GNSS) data from a GNSS sensor coupled to the vehicle along at least a portion of the sidewalk due to poor reception.

37. The system of claim 33, wherein the sidewalk segment is generated by determining that a portion of a LIDAR point cloud does not have a sufficient curvature to be considered a roadway.

38. The system of claim 33, wherein the grass segment is generated by determining that a portion of a LIDAR point has roughness above a predetermined threshold.

39. The system of claim 33, wherein the map comprises an obstacle segment and an alley segment, the obstacle segment generated by determining that the obstacle segment does not meet requirements of the sidewalk segment, the alley segment, the curb cut segment, and the grass segment.

40. The system of claim 33, wherein the controller is further configured to:
identify a predetermined LIDAR landmark in the map;
determine a second command to send to a control system of the vehicle based on the predetermined LIDAR landmark and the map; and
output the second command to the control system of the vehicle to advance the vehicle down the sidewalk.

41. The system of claim 40, wherein the predetermined LIDAR landmark is a curb cut.

42. The system of claim 33, wherein the map is previously generated by manually piloting the vehicle along the sidewalk without any snow covering the sidewalk.

43. A method for navigating a sidewalk, the method comprising:
receiving LIDAR data from at least one LIDAR sensor mounted to a vehicle;
determining a command to send to a control system of the vehicle based on the LIDAR data and a map comprising a sidewalk segment, a curb cut segment, and a grass segment, the map being previously generated based on LIDAR data of the sidewalk; and
outputting the command to the control system of the vehicle to advance the vehicle down the sidewalk.
